(19) United States
(12) Patent Application Publication
(10) Pub. No.: US 2026/0086265 A1
(43) Pub. Date: Mar. 26, 2026

(54) LIGHT CURTAIN

(71) Applicant: Keyence Corporation, Osaka (JP)

(72) Inventors: Hiroki MINAMIHARA, Osaka (JP); Tatsuki ASUKA, Osaka (JP); Takahiro TSUMOCHI, Osaka (JP)

(73) Assignee: Keyence Corporation, Osaka (JP)

(21) Appl. No.: 19/294,384

(22) Filed: Aug. 8, 2025

(30) Foreign Application Priority Data
Sep. 24, 2024 (JP) 2024-165342

(51) Int. Cl. G01V 8/20; G08B 13/183

(52) U.S. Cl. CPC G01V 8/20; G08B 13/183

(57) ABSTRACT

The light curtain includes a synchronization unit that synchronizes a light projection timing of a light projector and a light reception timing of a light receiver by optical communication. A safety signal generated based on whether or not an optical axis formed between the light projector and the light receiver is in a light shielding state is output to an outside. The light curtain includes a first operation indicator lamp provided in the light projector, a second operation indicator lamp provided in the light receiver, optical elements provided in each of the light projector and the light receiver and configured to interlock and display the first operation indicator lamp and the second operation indicator lamp, and a control circuit configured to interlock and display the first operation indicator lamp and the second operation indicator lamp by using the at least one set of optical elements.

### CROSS-REFERENCE TO RELATED APPLICATIONS

The present application claims foreign priority based on Japanese Patent Application No. 2024-165342, filed September 24, 2024, the contents of which are incorporated herein by reference.

### BACKGROUND OF THE INVENTION

### TECHNICAL FIELD

The invention relates to a light curtain.

### DESCRIPTION OF THE RELATED ART

A light curtain is an aspect of a multiple-optical-axis photoelectric sensor. The light curtain detects a person or an object depending on whether or not a plurality of optical axes formed between a light projector and a light receiver are shielded.

Some light curtains include an operation indicator lamp. The operation indicator lamp is used, for example, to display information such as (1) a turned-on or turned-off state of a power supply, (2) a turned-on or turned-off state of an output signal switching device [OSSD] output, that is, a light incident and light shielding state, and (3) an error state. For example, the operation indicator lamp is turned off in a case where all of a plurality of light receiving elements provided in a light receiver receive light beams emitted from a plurality of light projecting elements provided in a light projector, and is turned on otherwise. In addition, a turned-on state of the operation indicator lamp also changes when an error occurs in the light curtain. A worker can visually recognize an operation state of the light curtain by looking at the operation indicator lamp of the light curtain.

In addition, in the light curtain, it is necessary to match drive timings of the light projecting element and the light receiving element, that is, to synchronize a light projecting timing and a light receiving timing, in terms of a detection principle of an optical axis. Two types of synchronization systems of a wired synchronization system and an optical synchronization system have been known.

In the wired synchronization system, the light projector and the light receiver are connected by a cable, and the light projection timing and the light reception timing are synchronized by wired communication via the cable. The wired synchronization system is stronger in light mutual interference than the optical synchronization system. However, in the wired synchronization system, a wiring work of the cable is essential. In particular, in a case where the light projector and the light receiver are separated from each other, the wiring work is easily complicated.

In the optical synchronization system, a synchronization pulse is projected from the light projector. The synchronization pulse is a pulse signal for timing synchronization and has a unique pulse pattern. The light receiver synchronizes the light reception timing in accordance with the light projection timing of the synchronization pulse. The optical synchronization system does not require a wiring work between the light projector and the light receiver, and has a high degree of freedom in wiring. However, the optical synchronization system is weaker in light mutual interference than the wired synchronization system.

Note that, in recent years, in order to enhance resistance to the light mutual interference, redundancy of detection pulses by increasing a speed of a detection circuit, improvement of disturbance resistance, and the like have been promoted.

Thus, the number of light curtains that adopt the optical synchronization system is increasing.

The operation indicator lamp of the light curtain is generally provided in both the light projector and the light receiver. In this case, there is a need to interlock the turned-on state of the operation indicator lamp in both the light projector and the light receiver. For example, for (1) the turned-on or turned-off state of the power supply and (3) the error state described above, states of the light projector and the light receiver may be different from each other. On the other hand, for (2) the turned-on or turned-off state of the OSSD output, that is, the light incident and light shielding state, the turned-on state of the operation indicator lamp needs to be common between the light projector and the light receiver.

Accordingly, in order to enhance the visibility of the operation indicator lamp, it is desirable to interlock and display the operation indicator lamp in both the light projector and the light receiver. In order to realize such interlocking and display of the operation indicator lamp, it is necessary to notify the light projector of the turned-on or turned-off state of the OSSD output from the light receiver.

For example, as disclosed in Japanese Patent Application Laid-Open No. 2002-124169, in a light curtain that adopts a wired synchronization system, a light projector and a light receiver are originally connected via a cable. Thus, it is sufficient to add a communication line for interlocking and display control in the cable.

On the other hand, in the light curtain that adopts the optical synchronization system, there is no communication path from the light receiver to the light projector. Accordingly, in order to interlock and display the operation indicator lamp in both the light projector and the light receiver, it is necessary to separately lay the communication line for interlocking and display control between the light projector and the light receiver. That is, the wiring work between the light projector and the light receiver is required, and the advantage of the optical synchronization system is impaired.

### SUMMARY OF THE INVENTION

In view of the above problems, an object of the invention is to improve wiring workability in a case where an operation indicator lamp is provided in a light curtain of an optical synchronization system.

A light curtain according to the invention includes, for example, a light projector including a plurality of first light projecting elements, a light receiver arranged to face the light projector, and including a plurality of first light receiving elements configured to receive light beams projected from the plurality of first light projecting elements, and a synchronization unit configured to synchronize a light projection timing of the light projector and a light reception timing of the light receiver by optical communication, and a safety signal generated based on whether or not each of a plurality of optical axes formed between the light projector and the light receiver is in a light shielding state is output to an outside. The light curtain includes a first operation indicator lamp provided in the light projector and configured to display an operation state of the light curtain, a second operation indicator lamp provided in the light receiver and configured to display the operation state of the light curtain, at least one set of optical elements provided in each of the light projector and the light receiver and configured to interlock and display the first operation indicator lamp and the second operation indicator lamp, and a control circuit configured to interlock and display the first operation indicator lamp and the second operation indicator lamp by using the at least one set of optical elements.

Note that, other characteristics, elements, steps, advantages, and features will be more apparent from the following detailed description and the accompanying drawings.

According to the invention, dedicated wiring for interlocking the operation indicator lamps provided in both the light projector and the light receiver becomes unnecessary. Accordingly, wiring workability in a case where the operation indicator lamp is provided in the light curtain of the optical synchronization system can be improved.

### BRIEF DESCRIPTION OF THE DRAWINGS

FIG. 1 is a diagram illustrating a schematic configuration of a light curtain;

FIG. 2 is a perspective view illustrating an overall configuration of a light projector;

FIG. 3 is a front view illustrating an overall configuration of the light projector;

FIG. 4 is a perspective view illustrating one end of the light projector;

FIG. 5 is a functional block diagram of the light curtain;

FIG. 6 is a diagram illustrating a first embodiment of the light projector;

FIG. 7 is a diagram illustrating an arrangement example of indicator lamp light sources according to the first embodiment;

FIG. 8 is a diagram illustrating a relationship between a light emission color and an operation mode;

FIG. 9 is a diagram illustrating an arrangement example of indicator lamp light sources according to a second embodiment;

FIG. 10 is a diagram illustrating a display pattern example according to the second embodiment;

FIG. 11 is a diagram illustrating an arrangement example and a display pattern example of indicator lamp light sources according to a third embodiment;

FIG. 12 is a diagram illustrating an arrangement example and a display pattern example of indicator lamp light sources according to a fourth embodiment;

FIG. 13 is a diagram illustrating a relationship between an average light reception amount and a display pattern;

FIG. 14 is a diagram illustrating a relationship between a minimum light reception amount and a display pattern;

FIG. 15 is a diagram illustrating a turned-on image (first example) of a light curtain;

FIG. 16 is a diagram illustrating a turned-on image (second example) of a light curtain;

FIG. 17 is a functional block diagram of a light curtain having a display pattern control function;

FIG. 18 is a diagram illustrating a processing flow of display pattern control;

FIG. 19 is a diagram illustrating a configuration example of a light curtain according to a fifth embodiment;

FIG. 20 is a schematic view illustrating an example of optical axis formation;

FIG. 21 is a diagram illustrating a processing flow of interlocking and display control;

FIG. 22 is a plan view illustrating a configuration example of a light receiver;

FIG. 23 is a perspective view illustrating a configuration example of the light receiver;

FIG. 24 is a diagram illustrating an example of light mutual interference among a plurality of light curtains;

FIG. 25 is a diagram illustrating an example of optical axis drive control; and

FIG. 26 is a longitudinal sectional view illustrating an example of a light receiver including a light leakage suppression mechanism.

### DETAILED DESCRIPTION

### Light Curtain

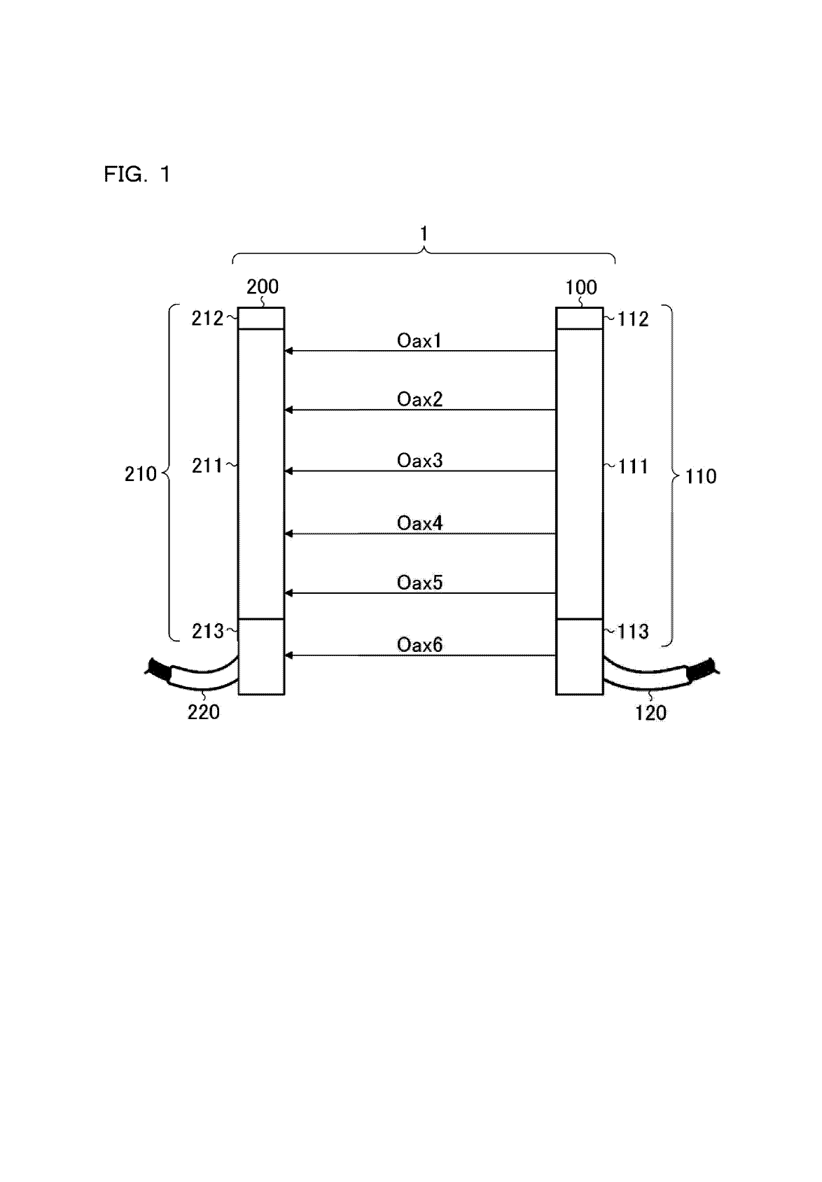

FIG. 1 is a diagram illustrating a schematic configuration of a light curtain. The light curtain 1 of the present configuration example is an aspect of a multiple-optical-axis photoelectric sensor, and generally includes a pair of a light projector 100 and a light receiver 200.

The light curtain 1 detects a person or an object depending on whether or not at least one of a plurality of optical axes (six optical axes Oax1 to Oax6 in this drawing) formed at intervals from each other between the light projector 100 and the light receiver 200 arranged in parallel is shielded. For example, the light curtain 1 is provided at an entrance or the like of a dangerous region where a dangerous source such as a press machine is placed, and can be used as a safety device for detecting intrusion or presence of a worker.

The light projector 100 and the light receiver 200, respectively, include elongated (up to 2 m or more) housings 110 and 210 and cables 120 and 220 connected thereto.

The housing 110 includes a hollow metal case 111 extending in a longitudinal direction, and hollow end caps 112 and 113 (corresponding to end members) connected to both ends of the metal case 111, respectively. Similarly, the housing 210 includes a hollow metal case 211 extending in a longitudinal direction, and hollow end caps 212 and 213 (corresponding to end members) connected to both ends of the metal case 211, respectively. In the present embodiment, the longitudinal direction is a direction substantially parallel to a direction in which the plurality of optical axes formed between the light projector 100 and the light receiver 200 are arranged at intervals.

As described above, when the metal cases 111 and 211 having high rigidity are adopted as the cases of the housings 110 and 210, the elongated housings 110 and 210 are less likely to be deformed. Accordingly, arrangement adjustment (for example, angle adjustment for arranging both housings in parallel) of the light projector 100 and the light receiver 200 becomes relatively easy. Note that, for example, an inexpensive and lightweight aluminum extrusion-molded product may be used as the metal cases 111 and 211. In this case, the metal cases 111 and 211 all have the same section regardless of where the metal cases are cut in an extrusion direction (= longitudinal direction).

Each of the end caps 112, 113, 212, and 213 may be formed by injection molding by using a resin material, or may be formed by die casting by using a metal material such as zinc. Note that, interfaces with the cables 120 and 220 can be mounted on the end caps 113 and 213 on a lower side of this drawing. Thus, the end caps 113 and 213 may be larger than the end caps 112 and 212 on an upper side of this drawing.

### Light Projector

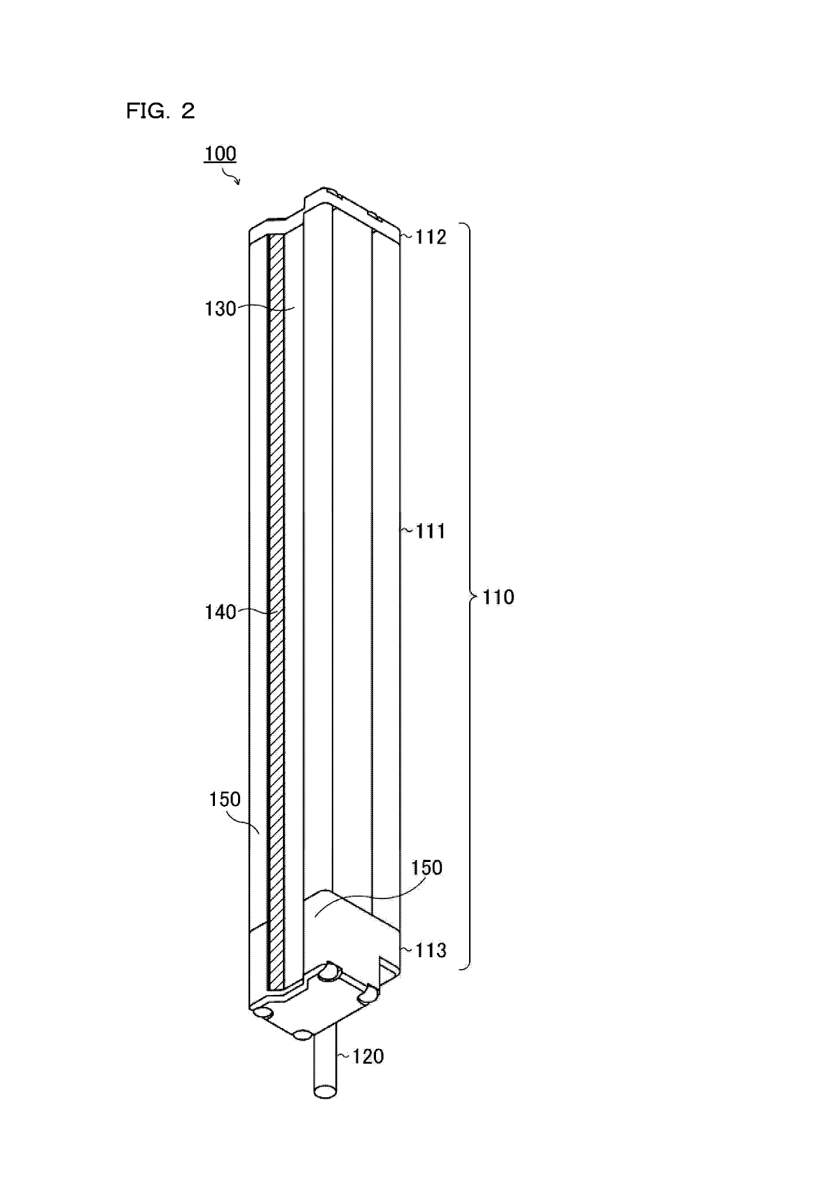

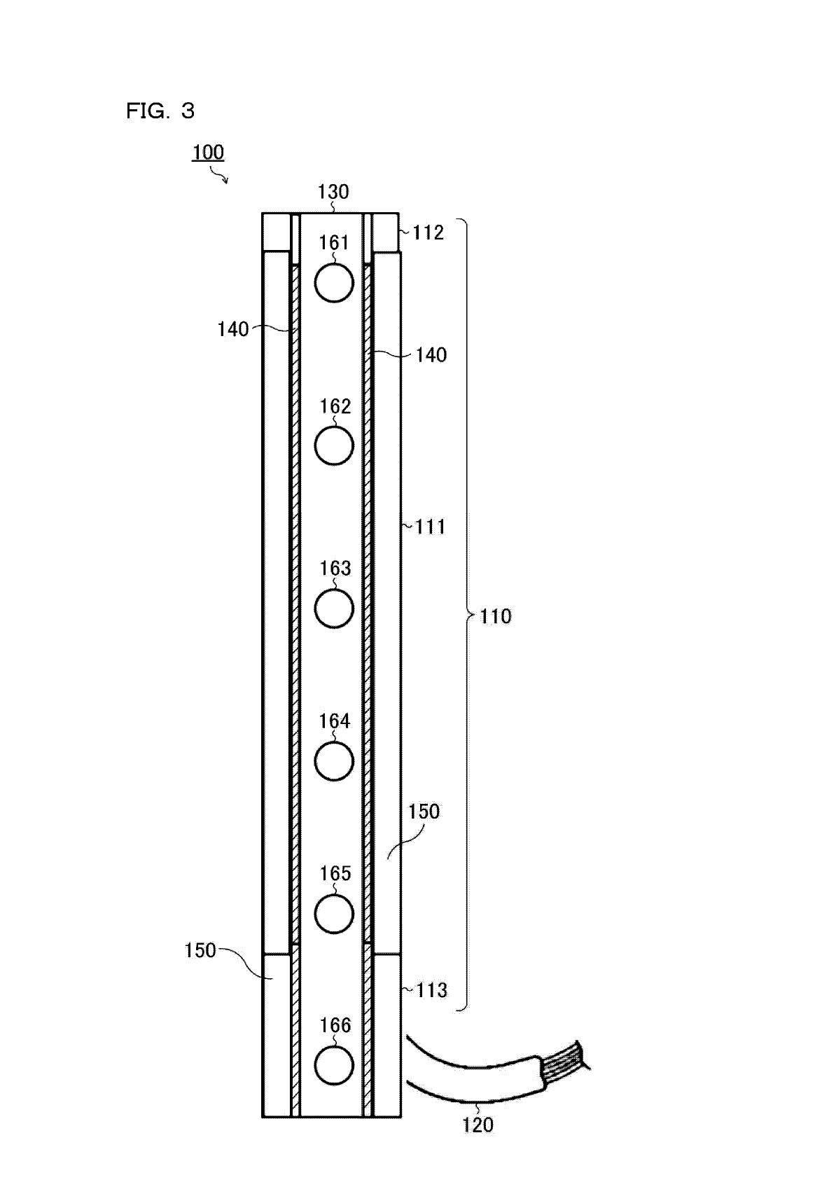

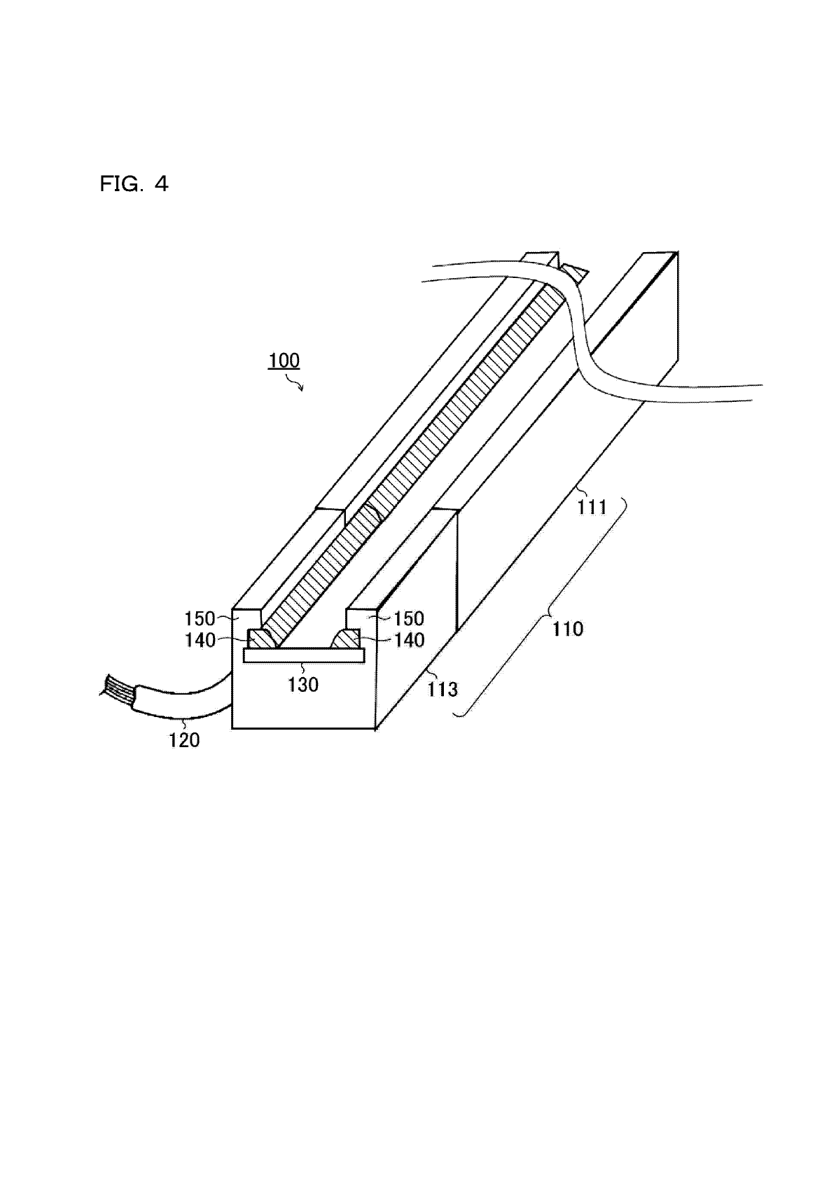

FIGS. 2 and 3 are a perspective view and a front view, respectively, illustrating an overall configuration of the light projector 100. In addition, FIG. 4 is a perspective view illustrating one end of the light projector 100.

As described above, the light projector 100 includes the housing 110 and the cable 120. In addition, the housing 110 includes the metal case 111 and the end caps 112 and 113. Further, the light projector 100 includes a front cover 130, indicator lamps 140, and bumpers 150.

The front cover 130 is an elongated light transmission plate attached to cover a front opening (= detection window) of the housing 110. In the front opening of the housing 110, light projecting elements 161 to 166 for forming the plurality of optical axes Oax1 to Oax6 are arranged at equal intervals along a longitudinal direction. That is, the front cover 130 is attached to the housing 110 so as to cross the plurality of optical axes Oax1 to Oax6. The front cover 130 may be a light-transmissive resin plate (acrylic plate or the like) extrusion-molded or may be a glass plate. The light-transmissive properties of the member used as the front cover 130 in the present embodiment refer to light-transmissive properties to the extent that light beams of the light projecting elements 161 to 166 forming the plurality of optical axes Oax1 to Oax6 are not excessively diffused out of the optical axes and are received by light receiving elements 261 to 266 to be described later with a certain light amount or more. As described above, since the light-transmissive member is used for the front cover 130, a worker can visually recognize the light projecting elements 161 to 166 through the front cover 130.

Note that, the light projecting element (the light projecting element 166 in FIG. 3) corresponding to at least one optical axis among the plurality of optical axes Oax1 to Oax6 may be arranged in the end cap 113. That is, the light projecting elements 161 to 166 may be arranged at equal intervals in the longitudinal direction over the entire region from one end to the other end of the light projector 100. In addition, the cable 120 may extend from a back surface (or side surface) of the end cap 113 instead of extending from a lower surface of the end cap 113. With such a configuration, the light projector 100 can be installed close to an installation surface (floor surface or the like). Accordingly, dead space-less can be realized.

The indicator lamps 140 are controlled to be turned on or off with a light emission color corresponding to, for example, an operation state of the light curtain 1 (an optical-axis detection state, a self-diagnosis result, or the like) or a work instruction regarding putting in and taking out an object. That is, the indicator lamp 140 functions as an operation indicator lamp or a work instruction lamp. Accordingly, the worker can visually recognize the operation state or the work instruction of the light curtain 1 by looking at the indicator lamps 140 of the light curtain 1.

In particular, the indicator lamps 140 are arranged outward from an outer surface of at least one of the front cover 130 and the housing 110 along a longitudinal direction, or are formed in series with the front cover 130 (details of a structure will be described later). With reference to this drawing, the indicator lamps 140 are provided on both sides of the front cover 130. With the indicator lamps 140 arranged or formed in this manner, it is possible to perform highly visible display without impairing the rigidity of the housing 110. More specifically, the indicator lamp 140 is an elongated extrusion-molded product, and is arranged such that the longitudinal direction of the indicator lamp 140 is along the longitudinal direction of the housing 110. Note that, the indicator lamps 140 may be arranged along the longitudinal direction of the housing 110, and a manufacturing method therefor is not limited to extrusion-molding, and a shape of the indicator lamp 140 may not be the elongated shape. For example, a plurality of members functioning as the indicator lamps 140 may be arranged along the longitudinal direction of the housing 110.

In addition, the indicator lamp 140 is a light diffusing member that diffuses light incident from an indicator lamp light source 170 (not illustrated) accommodated inside the housing 110 in various directions. More specifically, the indicator lamp 140 contains a light diffusing body that diffuses light in various directions. In the configuration in which the light diffusing member as the indicator lamp 140 contains the light diffusing body, even in a case where the number of indicator lamp light sources 170 is small with respect to a size of a surface of the indicator lamp 140, since the indicator lamp 140 can be relatively uniformly illuminated, highly visible display can be performed. In the present embodiment, the indicator lamp 140 is milky white because the indicator lamp is made of a transparent resin to which fine particles are added. In a case where a base resin is not transparent but has a specific color, the specific color and milky white are mixed. In a case where the indicator lamp 140 is made of a milky white resin (silicone or the like) in addition to the configuration in which the light diffusing member contains the light diffusing body, it is possible to obtain an action of relatively uniformly illuminating the indicator lamp 140. The light diffusing member as the indicator lamp 140 may be a member that diffuses the light from the indicator lamp light source 170 such that the light can be visually recognized from more directions, or a member that diffuses the light from the indicator lamp light source 170 to such an extent that it is difficult to visually recognize a contour of the indicator lamp light source 170 from an outside of the indicator lamp 140. For example, a light diffusing member having a surface machined to diffuse the light from the indicator lamp light source 170 may be arranged as the indicator lamp 140. For example, emboss machining is known as surface machining for diffusing light. With the configuration in which the light diffusing member having the machined surface is arranged as the indicator lamp 140, in a case where a region in which light is relatively easily diffused and a region in which light is relatively less easily diffused are provided in one member, it is easy to manufacture such a member.

The bumpers 150 protrude outward from a region, of the outer surface of the front cover 130, which crosses the plurality of optical axes Oax1 to Oax6, and are arranged along the longitudinal direction of the housing 110 (details of a structure will be described later).

With reference to this drawing, a pair of bumpers 150 is formed so as to protrude from both sides of the front cover 130. That is, the front cover 130 is disposed in a narrow valley sandwiched between the pair of bumpers 150 (twin bumpers proposed by the applicant of the present application) positioned on both sides thereof and protruding forward. Thus, even though the object collides with a front surface of the light projector 100, the impact thereof is received by the bumpers 150. Accordingly, the front cover 130 is less likely to be damaged. Note that, the bumper 150 may be made of a hard material such as metal.

In addition, a configuration of the light receiver 200 is basically similar to a configuration of the light projector 100. Accordingly, in the description of FIGS. 2 to 4, the configuration of the light receiver 200 can be understood by appropriately reading the light projector 100 and the light projecting elements 161 to 166 with the light receiver 200 and the light receiving elements 261 to 266, respectively, and appropriately replacing reference numerals in other 100 series with reference numerals in 200 series. In addition, the same applies to the following description.

### Functional Block

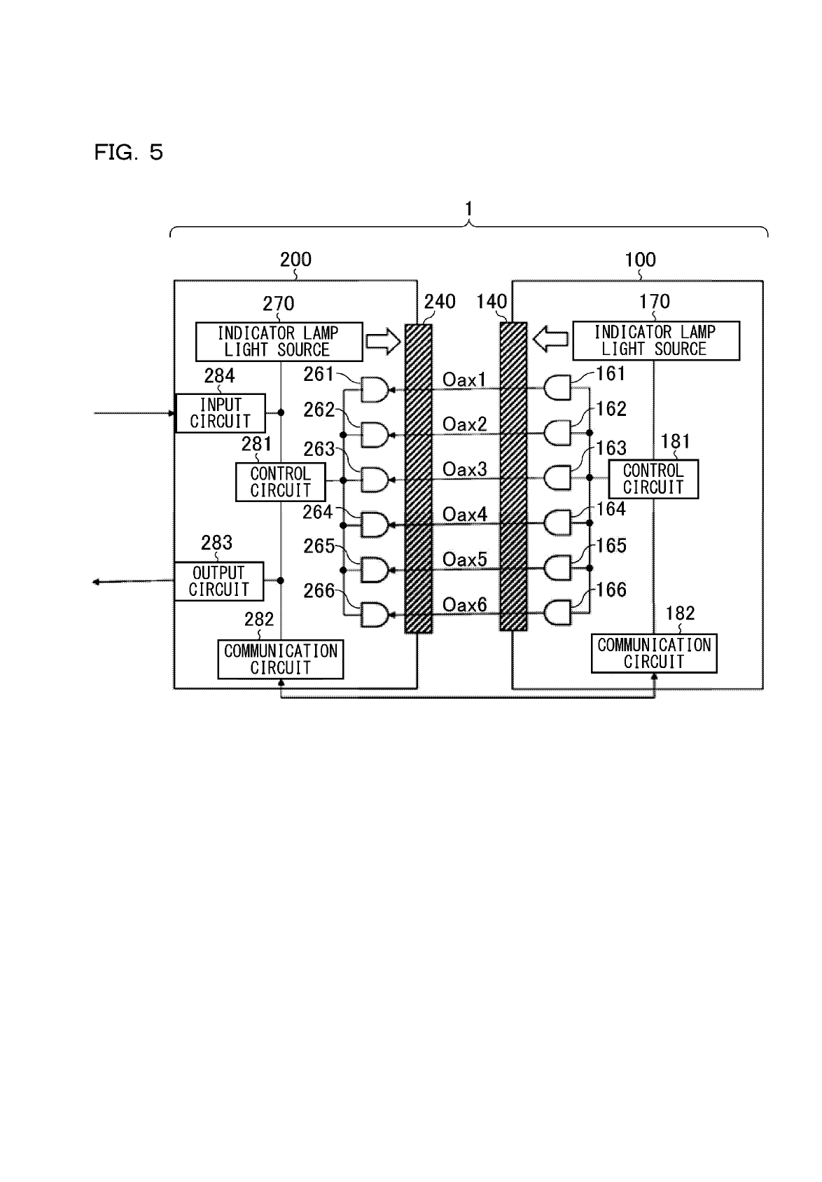

FIG. 5 is a functional block diagram of the light curtain 1. In the light curtain 1 of the present configuration example, the light projector 100 includes the indicator lamps 140, the light projecting elements 161 to 166, the indicator lamp light source 170, a control circuit 181, and a communication circuit 182.

The light projecting elements 161 to 166 are arranged at equal intervals at a predetermined pitch along the longitudinal direction of the light projector 100. The light projecting elements 161 to 166 sequentially project a plurality of light beams for, respectively, forming the plurality of optical axes Oax1 to Oax6 toward the light receiver 200 (in particular, the light receiving elements 261 to 266) in a time division manner based on a light projection control signal input from the control circuit 181. Note that, the light projecting elements 161 to 166 may be, for example, light emitting diodes that emit infrared light beams.

The indicator lamp light source 170 supplies light for display toward the indicator lamps 140 based on a display control signal input from the control circuit 181. The indicator lamp light source 170 may be switchable between a plurality of light emission colors (for example, red, green, and orange) in accordance with the operation state of the light curtain 1, the work instruction, or the like.

Note that, the indicator lamp light source 170 may be pulse-turned on at a timing temporally offset from a light projection or light reception timing of each of the plurality of optical axes Oax1 to Oax6. According to such turned-on or turned-off control, interference with the optical-axis detection by the indicator lamp light source 170 can be suppressed.

The indicator lamp 140 diffuses light incident from the indicator lamp light source 170 in various directions. The worker can visually recognize the operation state of the light curtain 1, the work instruction, or the like by looking at the indicator lamps 140.

In response to an instruction from the light receiver 200, the control circuit 181 generates the light projection control signal so as to sequentially drive the light projecting elements 161 to 166 in a time division manner. In addition, the control circuit 181 generates the display control signal so as to turn on or off the indicator lamp light source 170 in any light emission color. Further, the control circuit 181 exchanges various types of information with the communication circuit 182.

The communication circuit 182 performs wired or wireless communication with the light receiver 200 (in particular, the communication circuit 282). For example, the communication circuit 182 receives an input of information regarding the operation state (an optical-axis detection state, a self-diagnosis result, and the like) of the light curtain 1 from the light receiver 200 and transmits the information to the control circuit 181.

On the other hand, the light receiver 200 includes an indicator lamp 240, light receiving elements 261 to 266, an indicator lamp light source 270, a control circuit 281, a communication circuit 282, an output circuit 283, and an input circuit 284.

The light receiving elements 261 to 266 are arranged at equal intervals at the same pitch as the light projecting elements 161 to 166 along the longitudinal direction of the light receiver 200. The light receiving elements 261 to 266 sequentially receive a plurality of light beams for forming the plurality of optical axes Oax1 to Oax6 in a time division manner based on a light reception control signal input from the control circuit 281. Note that, the light receiving elements 261 to 266 may be, for example, photodiodes or phototransistors that output electric signals corresponding to a light reception amount of infrared light.

The indicator lamp light source 270 supplies light for display toward the indicator lamp 240 based on a display control signal input from the control circuit 281. Similarly to the indicator lamp light source 170, the indicator lamp light source 270 may be switchable between a plurality of light emission colors (for example, red, green, and orange) in accordance with the operation state of the light curtain 1, the work instruction, or the like.

Note that, the indicator lamp light source 270 may be pulse-turned on at a timing temporally offset from the light projection or light reception timing of each of the plurality of optical axes Oax1 to Oax6. According to such turned-on or turned-off control, interference with the optical-axis detection by the indicator lamp light source 270 can be suppressed.

In addition, a case where the indicator lamp light source 270 is continuously turned on will be considered. In this case, it is desirable that a saturation prevention circuit (= a subtraction circuit for a DC component) is provided such that the electric signals output from the light receiving elements 261 to 266 are not saturated even though direct-current light from the indicator lamp light source 270 is received by the light receiving elements 261 to 266.

The indicator lamp 240 diffuses light incident from the indicator lamp light source 270 in various directions. The worker can visually recognize the operation state of the light curtain 1, the work instruction, or the like by looking at the indicator lamp 240.

In addition, since the indicator lamps 140 and 240 are provided on both the light projector 100 and the light receiver 200, respectively, highly visible display can be performed.

The control circuit 281 generates the light reception control signal so as to sequentially enable the light receiving elements 261 to 266 in a time division manner in synchronization with a drive timing of each of the light projecting elements 161 to 166. In addition, the control circuit 281 generates the display control signal so as to turn on or off the indicator lamp light source 270 in any light emission color. Further, the control circuit 281 exchanges various types of information with the communication circuit 282, the output circuit 283, and the input circuit 284.

In addition, the control circuit 281 monitors a light incident state or a light shielding state of each of the plurality of optical axes Oax1 to Oax6. For example, the control circuit 281 may output an operation permission signal (ON signal) when all of the plurality of optical axes Oax1 to Oax6 are in the light incident state. On the other hand, the control circuit 281 may output an operation non-permission signal (OFF signal) when at least one of the plurality of optical axes Oax1 to Oax6 is in the light shielding state.

Further, the control circuit 281 may have a function of self-diagnosing whether or not the light incident state or light shielding state of each of the plurality of optical axes Oax1 to Oax6 can be correctly monitored. Note that, as the self-diagnosis method, for example, the control circuit 281 and the output circuit 283 (for example, an output signal switching device [OSSD] output) may be multiplexed, and matching or mismatching of multiplexed signals may be determined.

For example, when the multiplexed signals are matched with each other, OK diagnosis (= a diagnosis result indicating that the state can be correctly monitored) is made. On the other hand, when the multiplexed signals are not matched with each other, NG diagnosis (= a diagnosis result indicating that the state cannot be correctly monitored) is made. Note that, in a case where the NG diagnosis is made, the operation non-permission signal (OFF signal) may be output regardless of the light incident state of each of the plurality of optical axes Oax1 to Oax6.

Note that, information that can be used for safety control is safety information, and general information that cannot be used for safety control is unsafety information. For example, the OSSD output is one piece of safety information. The signal used for the turned-on or turned-off control of each of the indicator lamp light sources 170 and 270 may be a signal indicating the safety information or a signal indicating the unsafety information.

The communication circuit 282 performs wired or wireless communication with the light projector 100 (in particular, the communication circuit 182). For example, the communication circuit 282 receives an input of the information regarding the operation state (an optical-axis detection state, a self-diagnosis result, and the like) of the light curtain 1 from the control circuit 281 and transmits the information to the light projector 100.

The output circuit 283 performs wired or wireless communication with an external machine (for example, a safety controller). For example, the output circuit 283 receives an input of the operation state (an optical-axis detection state, a self-diagnosis result, or the like) of the light curtain 1 from the control circuit 281 and transmits the information to an external machine.

The input circuit 284 performs wired or wireless communication with an external machine (for example, a safety controller). For example, the input circuit 284 receives an input of a work instruction regarding putting in and taking out an object from an external machine and transmits the work instruction to the control circuit 281.

### First Embodiment

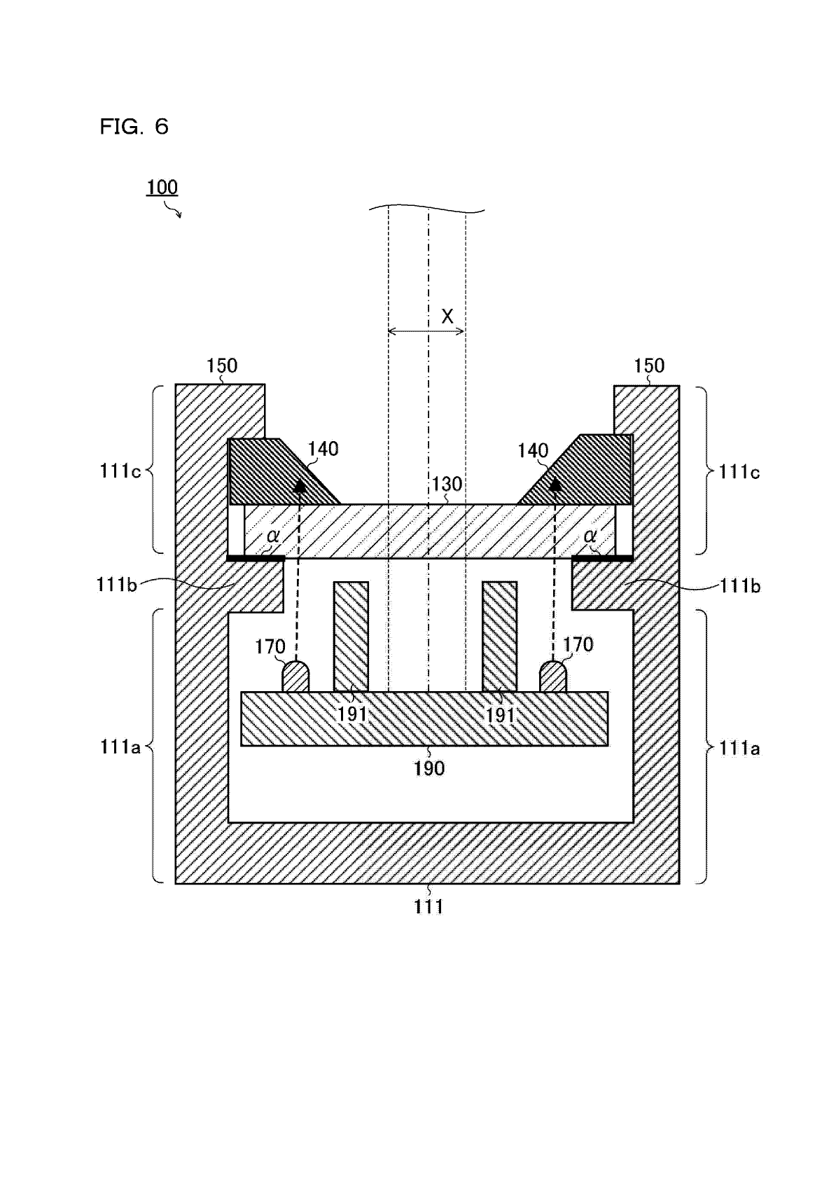

FIG. 6 is a diagram (= a schematic sectional view when a metal case 111 of a light projector 100 is cut at any position in a longitudinal direction) illustrating a first embodiment of the light projector 100. The light projector 100 of the present embodiment includes a housing 110 (only a metal case 111 is depicted in this drawing), a front cover 130, indicator lamps 140, bumpers 150, an indicator lamp light source 170, a substrate 190, and a light shielding plate 191.

The metal case 111 is an extrusion-molded product extending in the longitudinal direction of the light projector 100. With reference to this drawing, the metal case 111 includes a body 111a, a pair of first protruding stripes 111b, and a pair of second protruding stripes 111c.

The body 111a is a hollow member having a U-shaped section with an opening on an upper side of the drawing (= a front side of the light projector 100). The indicator lamp light source 170, the substrate 190, and the light shielding plate 191 are accommodated in an internal space of the body 111a.

The pair of first protruding stripes 111b protrudes from inner side surfaces of left side wall and right side wall of the body 111a toward an inside of the opening. That is, the pair of first protruding stripes 111b is arranged so as to face each other with a predetermined interval, sandwiching an optical-axis crossing region X (= a region crossing a plurality of optical axes Oax1 to Oax6). Note that, the pair of first protruding stripes 111b functions as cover attachment portions for supporting the front cover 130. As described above, a light-transmissive member is used for the front cover 130 as long as the light-transmissive member is provided at least in the optical-axis crossing region X and the optical axes Oax1 to Oax6 are not hindered. For example, in the present embodiment, a portion coming into contact with the pair of first protruding stripes 111b does not necessarily have light-transmissive properties.

The pair of second protruding stripes 111c extends further upward in the drawing from upper ends of the left side wall and the right side wall of the body 111a. In addition, each of the pair of second protruding stripes 111c has a distal end bent toward the inside of the opening. Note that, the pair of second protruding stripes 111c functions as the bumpers 150 for protecting the front cover 130. That is, in the present embodiment, the bumpers 150 described above are formed from the metal case 111. Accordingly, the fastness of the light projector 100 can be enhanced.

The front cover 130 is supported (suspended) at both ends across the pair of first protruding stripes 111b. The front cover 130 causes light beams forming the plurality of optical axes Oax1 to Oax6 to pass in the optical-axis crossing region X. Processing of improving liquid resistance is performed between the front cover 130 and the pair of first protruding stripes 111b (see a thick line α). For example, processing of arranging a packing and bonding with a liquid-resistant adhesive is performed. As described later, since bonding properties between the front cover 130 and the first protruding stripes 111b are enhanced by the indicator lamps 140, liquid resistance is further improved.

The indicator lamps 140 are arranged on both sides of the front cover 130 to be adjacent to the bumpers 150. With reference to this drawing, the indicator lamps 140 are arranged along the longitudinal direction of the light projector 100 in regions sandwiched between the first protruding stripes 111b and the distal ends (bent portions) of the second protruding stripes 111c, that is, in regions sandwiched between the bumpers 150 and the front cover 130.

Note that, the indicator lamp 140 diffuses light incident from the indicator lamp light source 170 via the front cover 130 in various directions. For example, the indicator lamp 140 may have a taper for refracting and diffusing the light incident from the indicator lamp light source 170 toward the inside of the opening.

With the indicator lamps 140 arranged in this manner, it is easy to see even from a side of the light projector 100. Accordingly, in the small-sized (small-diameter) light curtain 1 using the metal case 111, it is possible to perform highly visible display without impairing the rigidity of the housing 110. In particular, in a case where the pair of bumpers 150 is provided so as to protrude from both sides of the front cover 130, an effect of improving the visibility by the above arrangement can be more remarkable.

In addition, in the light projector 100 of the present embodiment, the indicator lamps 140 also function as pressing members for pressing and fixing the front cover 130 downward (= in a direction toward the first protruding stripes 111b). Accordingly, since the bonding properties between the front cover 130 and the first protruding stripe 111b are enhanced, liquid resistance can be improved by preventing liquid from entering the inside of the metal case 111. Note that, in order for the indicator lamps 140 to have the function as the pressing members, it is desirable that the indicator lamps 140 have appropriate elasticity.

The indicator lamp light source 170 is mounted on a main surface (= a surface facing the front cover 130) of the substrate 190. The indicator lamp light source 170 supplies light for display toward the indicator lamps 140 via the front cover 130. With reference to this drawing, the light emitted from the indicator lamp light source 170 passes between the pair of first protruding stripes 111b without being shielded by the pair of first protruding stripes 111b, and is supplied to the indicator lamps 140 via the front cover 130.

Note that, the number of indicator lamp light sources 170 is not limited. For example, a plurality of indicator lamp light sources 170 may be intermittently arranged or may be formed in series along the longitudinal direction of the light projector 100.

In addition, the indicator lamp light source 170 may include a lens for controlling a direction of the emitted light. For example, a lens that is optically designed so as to reduce a spread angle of light in a left-right direction in this drawing and to increase the spread angle of light in a depth direction in this drawing may be provided. According to such a lens, it is possible to reduce the number of indicator lamp light sources 170 while suppressing interference with the plurality of optical axes Oax1 to Oax6.

Note that, a type of the lens may be a point symmetrical lens (single lens arrangement) or a cylindrical lens (series arrangement by extrusion-molded product).

The light shielding plate 191 is provided between the indicator lamp light source 170 and the optical-axis crossing region X. Accordingly, since the light from the indicator lamp light source 170 toward the optical-axis crossing region X is shielded, the light emitted from the indicator lamp light source 170 is less likely to interfere with the plurality of optical axes Oax1 to Oax6.

In addition, a case where the optical axes Oax1 to Oax6 are formed by infrared light, and visible light (red light, green light, orange light, or the like) is emitted from the indicator lamp light source 170 is considered. In this case, a filter that transmits infrared light and shields visible light may be provided in the light receiver 200. In particular, in a case where the indicator lamps 240 are provided in the light receiver 200, a filter that transmits infrared light and shields visible light may be arranged so as not to shield the display of the indicator lamps 240. Filters may be provided in the light receiving elements 261 to 266, or a filter may be provided in a lens that guides light to the light receiving elements 261 to 266.

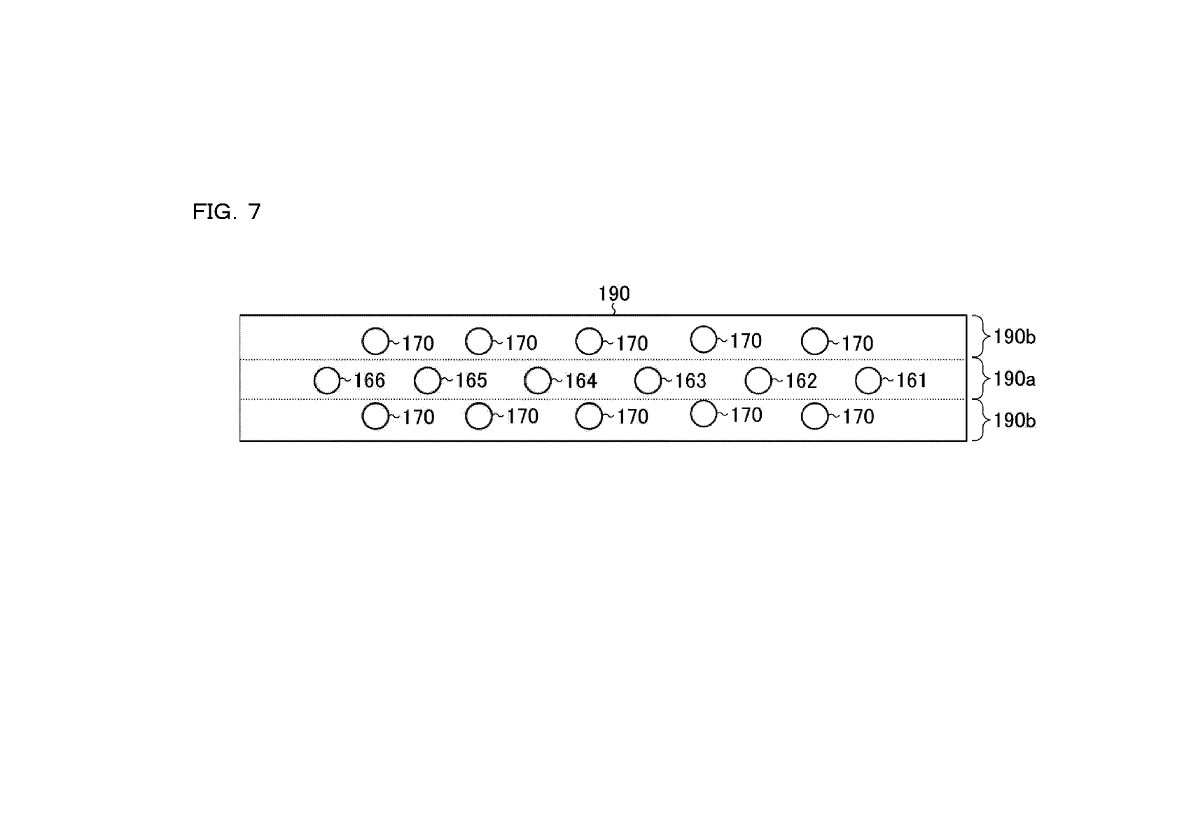

FIG. 7 is a diagram illustrating an arrangement example of the indicator lamp light sources 170 according to the first embodiment. As illustrated in this drawing, the light projecting elements 161 to 166 may be arranged at equal intervals along a longitudinal direction of the substrate 190 in a central region 190a of the substrate 190. On the other hand, the indicator lamp light sources 170 may be arranged at equal intervals along the longitudinal direction of the substrate 190 in an end region 190b of the substrate 190.

In particular, the light projecting elements 161 to 166 and the indicator lamp light sources 170 may be arranged such that positions in the longitudinal direction of the substrate 190 are shifted from each other (staggered). According to such an arrangement example, mutual interference between the light projecting elements 161 to 166 and the indicator lamp light sources 170 is suppressed.

Note that, the number and arrangement of the indicator lamp light sources 170 are not limited to the arrangement example in this drawing. For example, the number of indicator lamp light sources 170 can be reduced such that the light beams supplied to the indicator lamps 140 have some unevenness.

### Display Content

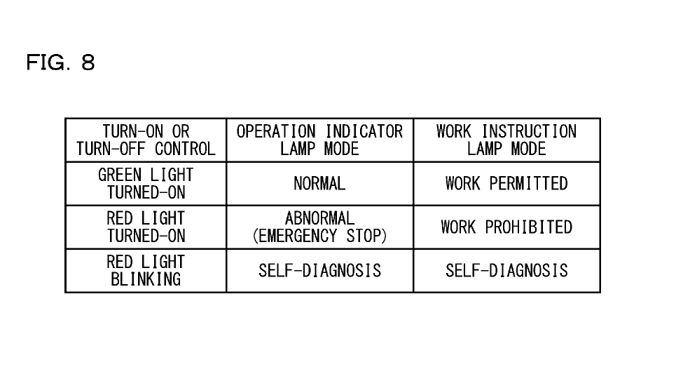

FIG. 8 is a diagram illustrating a relationship between a light emission color of the indicator lamp 140 and an operation mode. As illustrated in this drawing, the indicator lamp 140 can be switched to any one of an operation indicator lamp mode and a work instruction lamp mode. For example, a control signal for switching the operation mode of the indicator lamp 140 may be a 2-bit (four-value) digital signal input to the input circuit 284.

First, a case where the indicator lamp 140 is set to the operation indicator lamp mode will be described. When the operation indicator lamp mode is set, the indicator lamp 140 is controlled to be turned on or off with a light emission color corresponding to the operation state of the light curtain 1.

With reference to this drawing, for example, when the light curtain 1 is in a normal state (for example, a state where all of the plurality of optical axes Oax1 to Oax6 are not shielded), the indicator lamp 140 is turned on in green. On the other hand, when the light curtain 1 is in an abnormal state (for example, an emergency stop state where at least one of the plurality of optical axes Oax1 to Oax6 is shielded), the indicator lamp 140 is turned on in red. In addition, when the light curtain 1 is in an alarm notification state (for example, an NG diagnosis state by a self-diagnosis function), the indicator lamp 140 blinks in red.

Next, a case where the indicator lamp 140 is set to the work instruction lamp mode will be described. When the work instruction lamp mode is set, the indicator lamp 140 is controlled to be turned on or off with a light emission color corresponding to the work instruction signal received by the input circuit 284.

With reference to this drawing, for example, when the work instruction signal indicates a “work permitted state”, the indicator lamp 140 is turned on in green. On the other hand, when the work instruction signal indicates a “work prohibited state”, the indicator lamp 140 is turned on in red. In addition, when the work instruction signal indicates “self-diagnosis”, the indicator lamp 140 blinks in red. Note that, in the work instruction lamp mode, the indicator lamp 140 may be turned on in orange. A method for using a turned-on state may vary depending on a user.

In addition, in a case where the light curtain 1 is used under an environment where light emission of the indicator lamp 140 is not desirable, the indicator lamp 140 can be constantly turned off.

### Consideration on Reduction in Optical Axis Light Reception Amount

As described above, the light curtain includes two of the light projector and the light receiver, and the plurality of light projecting elements and the plurality of light receiving elements are arranged in an axial direction. When the light curtain is used, the light projector and the light receiver are arranged in parallel, and an angle is adjusted such that a light reception amount can be obtained by all the elements. The farther a distance between the light projector and the light receiver is, the more difficult it is to understand whether an orientation is correct, and the more difficult it is to see the display. Thus, it is difficult to adjust the angle.

The light curtain may be used in harsh environments such as dirt or bumps. Therefore, in order to protect a front cover of a detection unit, there is a product having a bumper shape protruding from the front cover. However, it is difficult to prevent adhesion of dirt to the front cover. When the adhesion of dirt accumulates and the light receiving elements cannot receive light with a sufficient light amount, the optical axis is in the light shielding state, and there is a possibility that activation of the device is stopped due to a safety output from the light curtain. Thus, maintenance for cleaning a glass surface of the front cover is required before a detection result of the optical axis is influenced.

In an environment where dirt adheres, it is required to install the light curtain so as to secure an optical axis light reception amount with a margin against a decrease in an optical axis light reception amount due to dirt (= a light reception amount every optical axis serving as a criterion for determining whether or not the optical axis is in the light shielding state). In addition, it is also required to perform maintenance before the optical axis becomes the light shielding state by confirming a decrease in the optical axis light reception amount over time.

In response to the above requirements, there is a model capable of confirming the optical axis light reception amount by the body of the light curtain. For example, in an existing model, a magnitude of the optical axis light reception amount is expressed by the number of a plurality of turned-on light emitting diodes [LEDs] or numeral display of seven segments. However, these displays are small and difficult to see from a long distance. Thus, it may be difficult to confirm the display at the time of adjusting the installation of the light curtain. In addition, even during operation of the light curtain, it is difficult to notice a decrease in the optical axis light reception amount unless the above-described small display is confirmed in consideration.

On the other hand, large-sized indicator lamps 140 and 240 are provided in the light curtain 1 described in the present specification so far such that an activation state of the light curtain 1 is easily visually recognized while achieving both size reduction and high visibility.

In view of the above consideration, hereinafter, a novel embodiment in which display interlocked with the optical axis light reception amount can be performed by the indicator lamps 140 and 240 with high visibility is proposed.

### Second Embodiment

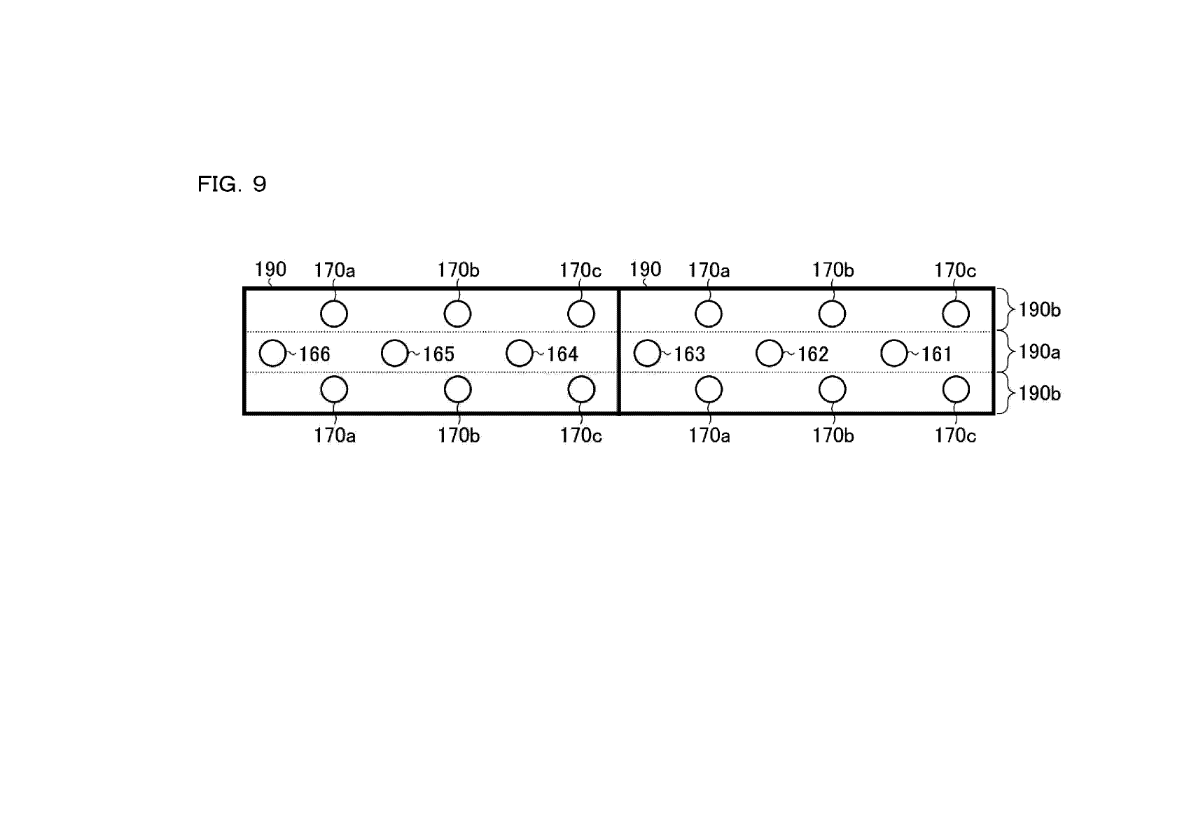

FIG. 9 is a diagram illustrating an arrangement example of an indicator lamp light source according to a second embodiment. In the present embodiment, a plurality of (two in this drawing) substrates 190 having an identical structure are cascade-connected along a longitudinal direction. With such a configuration, a light curtain 1 can be easily elongated by simply increasing the number of cascade connections of the substrates 190.

In this drawing illustrating a light projector 100, light projecting elements 161 to 166 may be arranged at equal intervals along the longitudinal direction of the substrate 190 in a central region 190a of the substrate 190, similarly to FIG. 7 described above. With reference to this drawing, the light projecting elements 161 to 163 are arranged on the substrate 190 on a right side of the drawing in an illustrated order from a right side to a left side of the drawing. On the other hand, on the substrate 190 on a left side of the drawing, the light projecting elements 164 to 166 are arranged in an illustrated order from a right side to a left side of the drawing. Note that, in a case where a configuration of a light receiver 200 is understood, each of the light projecting elements 161 to 166 may be read as light receiving elements 261 to 266.

On the other hand, the indicator lamp light sources 170 may be arranged at equal intervals along the longitudinal direction of the substrate 190 in an end region 190b of the substrate 190. In particular, the indicator lamp light sources 170 can be distinguished as indicator lamp light sources 170a, 170b, and 170c depending on a difference in each control system. With reference to this drawing, the indicator lamp light sources 170a, 170b, and 170c are arranged on two substrates 190 in an illustrated order from a left side to a right side of the drawing. Note that, although not illustrated in this drawing, the light curtain 1 includes an OSSD indicator lamp of which a display aspect changes in accordance with an OSSD output, separately from the indicator lamp light source 170. Thus, the display aspect of the indicator lamp light source 170 changes so as to indicate light reception states of the light receiving elements 261 to 266.

As described above, the light projecting elements 161 to 163 (or 164 to 166) and the indicator lamp light sources 170a, 170b, and 170c are arrayed on the common substrate 190, as one unit. In particular, the indicator lamp light sources 170a, 170b, and 170c are unitized as a set of three light sources.

Note that, as a modification, the light projecting elements 161 to 163 (or 164 to 166) and the indicator lamp light sources 170a, 170b, and 170c may be individual units. That is, a unit in which the light projecting elements 161 to 163 (or 164 to 166) are arrayed and a unit in which the indicator lamp light sources 170a, 170b, and 170c are arranged may be independent from each other.

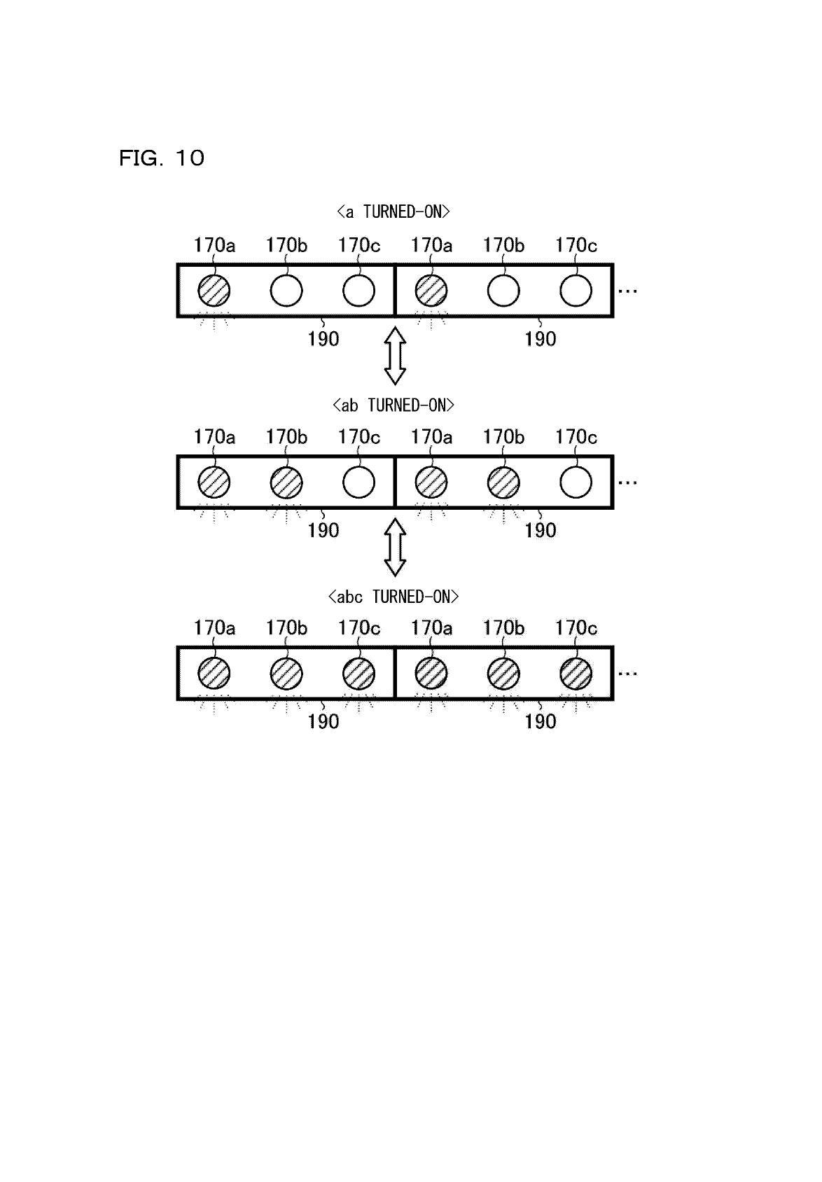

FIG. 10 is a diagram illustrating a display pattern example according to the second embodiment. In an upper part of this drawing, “a turned-on state” is depicted. In this “a turned-on state”, the indicator lamp light sources 170a are turned on, and both of the indicator lamp light sources 170b and 170c are turned off. Accordingly, a display pattern in which “turning on one, turning off two” is repeated from a left side to a right side of the drawing is obtained.

In a middle part of this drawing, an “ab turned-on state” is depicted. In this “ab turned-on state”, both the indicator lamp light sources 170a and 170b are turned on, and the indicator lamp light source 170c is turned off. Accordingly, a display pattern in which “turning on two, turning off one” is repeated from a left side to a right side of the drawing is obtained.

In a lower part of this drawing, an “abc turned-on state” is depicted. In this “abc turned-on state”, all of the indicator lamp light sources 170a, 170b, and 170c are turned on.

As described above, in a display pattern example according to the present embodiment, the indicator lamp light sources 170a, 170b, and 170c are appropriately intermittently turned on. Accordingly, the display pattern is switched to any one of the above three patterns in accordance with the optical axis light reception amount, and thus, the optical axis light reception amount can be discriminated only by looking at the large-sized indicator lamps 140 and 240. As a result, the light curtain 1 that is easily adjusted at the time of initial setting and has high maintainability is provided.

### Third Embodiment

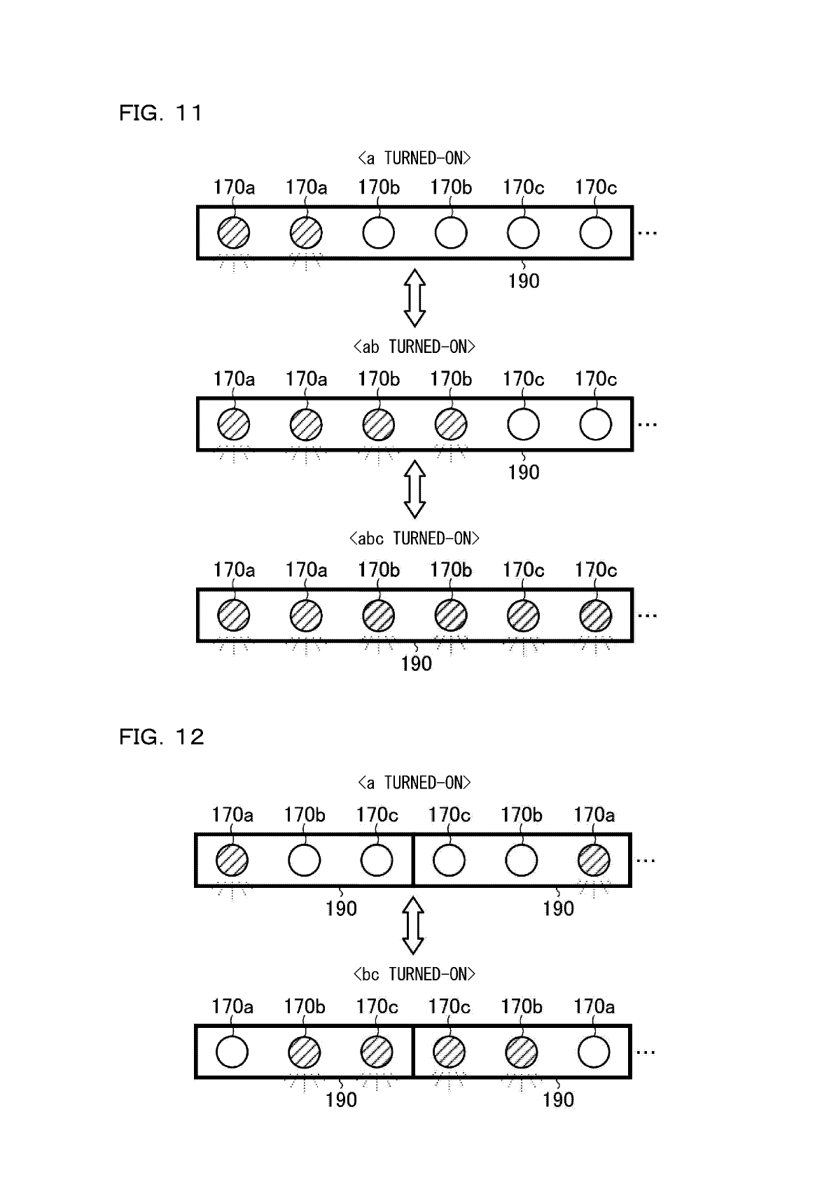

FIG. 11 is a diagram illustrating an arrangement example and a display pattern example of indicator lamp light sources according to a third embodiment. In the present embodiment, two indicator lamp light sources 170a, two indicator lamp light sources 170b, and two indicator lamp light sources 170c are arrayed on a common substrate 190, as one unit. That is, the indicator lamp light sources 170a, 170b, and 170c are unitized as a set of six light sources.

With reference to this drawing, two indicator lamp light sources 170a, two indicator lamp light sources 170b, and two indicator lamp light sources 170c are arranged on the substrate 190 in an illustrated order from a left side to a right side of the drawing.

In an upper part of this drawing, “a turned-on state” is depicted. In this “a turned-on state”, the indicator lamp light sources 170a are turned on, and both of the indicator lamp light sources 170b and 170c are turned off. Accordingly, a display pattern in which “turning on two, turning off four” is repeated from a left side to a right side of the drawing is obtained.

In a middle part of this drawing, an “ab turned-on state” is depicted. In this “ab turned-on state”, both the indicator lamp light sources 170a and 170b are turned on, and the indicator lamp light sources 170c are turned off. Accordingly, a display pattern in which “turning on four, turning off two” is repeated from the left side to the right side of the paper surface is obtained.

In a lower part of this drawing, an “abc turned-on state” is depicted. In this “abc turned-on state”, all of the indicator lamp light sources 170a, 170b, and 170c are turned on.

Note that, in the second embodiment (FIG. 10) described above, the number of indicator lamp light sources 170a, 170b, and 170c in a non-turned-on state (turned-off state) is increased or decreased by one such as 2, 1, and 0 every display pattern.

On the other hand, in the arrangement example of the indicator lamp light sources and the display pattern example according to the present embodiment, the number of indicator lamp light sources 170a, 170b, and 170c in the non-turned-on state is increased or decreased by two such as 4, 2, and 0 every display pattern. Accordingly, as compared with the second embodiment (FIG. 10) described above, a difference in a distance between the light sources to be intermittently turned on becomes large. As a result, the switching of the display pattern (and the change in the optical axis light reception amount) is easily recognized through the light diffusing body.

### Fourth Embodiment

FIG. 12 is a diagram illustrating an arrangement example and a display pattern example of indicator lamp light sources according to a fourth embodiment. Similarly to the second embodiment (FIG. 10) described above, in the present embodiment, indicator lamp light sources 170a, 170b, and 170c are unitized as a set of three. However, an array order of the indicator lamp light sources 170a, 170b, and 170c differs every substrate 190.

With reference to this drawing, the indicator lamp light sources 170a, 170b, and 170c are arranged on the substrate 190 on a left side of the drawing in an illustrated order from a left side to a right side of this drawing. On the other hand, the indicator lamp light sources 170a, 170b, and 170c are arranged in an illustrated order on the substrate 190 on a right side of this drawing from a right side to a left side of this drawing.

In an upper part of this drawing, “a turned-on state” is depicted. In this “a turned-on state”, the indicator lamp light sources 170a are turned on, and both of the indicator lamp light sources 170b and 170c are turned off. Accordingly, a display pattern in which “turning on one, turning off four, turning on one” is repeated from a left side to a right side of the drawing is obtained.

In a lower part of this drawing, an “bc turned-on state” is depicted. In this “bc turned-on state”, the indicator lamp light source 170a is turned on, and both the indicator lamp light sources 170b and 170c are turned off. Accordingly, a display pattern in which “turning off one, turning on four, turning off one” is repeated from a left side to a right side of the drawing is obtained.

As described above, in the arrangement example and the display pattern example of the indicator lamp light sources according to the present embodiment, the number of indicator lamp light sources 170a, 170b, and 170c in the non-turned-on state is increased or decreased by two such as 4, 2, and 0 every display pattern while maintaining a set of three units. Accordingly, similarly to the third embodiment (FIG. 11) described above, the switching of the display pattern (and the change in the optical axis light reception amount) is easily recognized.

### Relationship between Optical Axis Light Reception Amount and Display Pattern

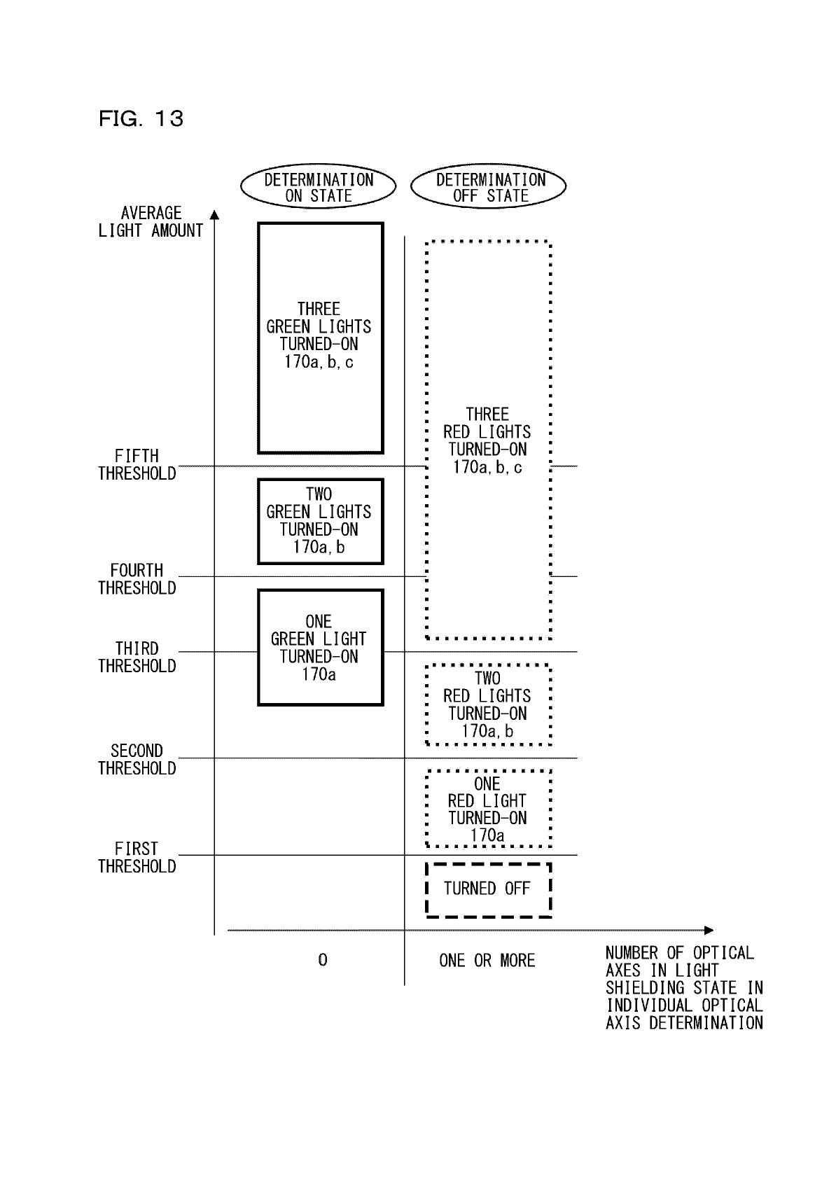

FIG. 13 is a diagram illustrating a relationship between the optical axis light reception amount (average light reception amount) and the display pattern. The optical axis light reception amount is converted by an A/D converter and is compared with a threshold. A determination criterion for determining the display pattern may be an average value (= average light reception amount) of the light reception amounts on the optical axes.

First, an ON state of the OSSD indicates a state where a condition that “the light reception amounts of all the optical axes are a first threshold or more” is satisfied for the light receiving elements 261 to 266, and the OSSD output is ON. In the present embodiment, for the sake of convenience, a state where the light receiving elements 261 to 266 satisfies the condition and the OSSD output can be turned on is set as a determination ON state, and the determination ON state is a state where “the light reception amounts of all the optical axes are the first threshold or more”. The first threshold is identical to a threshold for determining whether or not each individual optical axis is in the light shielding state. Thus, the average light reception amount in this state is high to some extent, and cannot be a value low enough to be considered as “complete light shielding”. That is, since the light reception amounts of all the optical axes are the first threshold or more, the average light reception amount cannot fall below the first threshold.

Accordingly, “OFF” display when the average light reception amount falls below the first threshold can be understood as a display aspect in which the light receiving elements 261 to 266 do not satisfy the condition that “the light reception amounts of all the optical axes are the first threshold or more”, that is, which is only in a determination OFF state. In this drawing, a horizontal axis is introduced to clarify this display aspect. The horizontal axis indicates a result of individual light reception amount determination for each optical axis (= the number of optical axes determined to be in the light shielding state by individual optical axis determination). Note that, an OFF state of the OSSD indicates a state where the condition that “the light reception amounts of all the optical axes are the first threshold or more” is not satisfied for the light receiving elements 261 to 266 and the OSSD output is OFF. In the present embodiment, for the sake of convenience, a state where the light receiving elements 261 to 266 do not satisfy the condition that “the light reception amounts of all the optical axes are the first threshold or more”, that is, a state where “the light reception amounts of at least one or more optical axes are less than the first threshold” is regarded as the determination OFF state. That is, in the determination ON state, the number of optical axes in the light shielding state is 0. On the other hand, in the determination OFF state, the number of optical axes in the light shielding state is 1 or more.

Note that, the individual light reception amount determination for each optical axis is performed only in the determination ON state (display color: green) and the determination OFF state (display color: red). Thus, a step of performing this determination on a flowchart to be described later is the same step as a step of comparing the average light reception amount with the threshold.

In addition, in the determination ON state and the determination OFF state, a threshold as a determination criterion for switching the number of turned-on indicator lamp light sources 170a, 170b, and 170c is shifted. First, the determination ON state will be described. As described above, the determination ON state is a state where the light reception amounts of all the optical axes are the first threshold or more. Thus, in the determination ON state, thresholds for switching the number of turned-on indicator lamp light sources (a fourth threshold and a fifth threshold in this drawing) are provided in a region where the average light reception amount is relatively high.

With reference to this drawing, when the average light reception amount is lower than the fourth threshold in the determination ON state, one green light is turned on (= a state where only the indicator lamp light source 170a is turned on in green). When the average light reception amount is higher than the fourth threshold and lower than the fifth threshold, two green lights are turned on (= a state where the indicator lamp light sources 170a and 170b are turned on in green). When the average light reception amount is higher than the fifth threshold, three green lights are turned on (= a state where the indicator lamp light sources 170a, 170b, and 170c are turned on in green). That is, as the average light reception amount increases, the number of turned-on green lights increases.

Note that, as the distance between the light projector 100 and the light receiver 200 increases, the light reception amount of each optical axis decreases. Although the light projector 100 and the light receiver 200 are provided in parallel and can normally receive light without contamination, it is also conceivable that the light reception amount decreases only due to an increase in the distance between the light projector 100 and the light receiver 200.

When the number of turned-on indicator lamp light sources 170a, 170b, and 170c is reduced in such a situation, information regarding installation and maintenance cannot be correctly transmitted. Thus, it is desirable to set the threshold so as to widen a region where the number of turned-on indicator lamp light sources 170a, 170b, and 170c is 3. With reference to this drawing, in the determination ON state, the fifth threshold for switching the number of turned-on indicator lamp light sources 170a, 170b, and 170c between three and two is set to be relatively low.

Next, the determination OFF state will be described. Switching control of the display pattern in the determination OFF state is useful when the light projector 100 and the light receiver 200 are installed. For example, a case where installation positions of the light projectors 100 and 200 are adjusted starting from the turned-off state where the number of turned-on indicator lamp light sources is 0 will be considered. In this case, in order to grasp directionality of the adjustment (= whether or not the installation positions are close to correct installation positions), it is desirable that the display pattern is switched even though the average light reception amount slightly increases or decreases.

Thus, in the determination OFF state, the thresholds (the first threshold, the second threshold, and the third threshold in this drawing) for switching the number of turned-on indicator lamp light sources are provided in a region where the average light reception amount is relatively low. For example, a relationship between the thresholds may be first threshold < second threshold < third threshold < fourth threshold < fifth threshold as illustrated in this drawing. In the embodiment illustrated in this drawing, all of the first threshold, the second threshold, and the third threshold do not influence the switching of the number of turned-on indicator lamp light sources in the ON state.

With reference to this drawing, when the average light reception amount is lower than the first threshold in the determination OFF state, the state becomes the turned-off state (= a state where the indicator lamp light sources 170a, 170b, and 170c are turned off) as described above. When the average light reception amount is higher than the first threshold and lower than the second threshold, one red light is turned on (= a state where only the indicator lamp light source 170a is turned on in red). When the average light reception amount is higher than the second threshold and lower than the third threshold, two red lights are turned on (= a state where the indicator lamp light sources 170a and 170b are turned on in red). When the average light reception amount is higher than the third threshold, three red lights are turned on (= a state where the indicator lamp light sources 170a, 170b, and 170c are turned on in red). That is, as the average light reception amount increases, the number of turned-on red lights increases.

As described above, in the determination ON state and the determination OFF state, the purpose of switching the display pattern is different in accordance with the optical axis light reception amount. Specifically, it is assumed that the display pattern switching in the turned-on green light in the determination ON state is useful for grasping dirt adhesion (necessity of maintenance) after the start of an operation of the light curtain 1. On the other hand, it is assumed that the display pattern switching in red light in the determination OFF state is useful for optical axis adjustment when the light curtain 1 is installed. Thus, in order to individually set optimal thresholds for the determination ON state and the determination OFF state, it is desirable to shift the thresholds between the determination ON state and the determination OFF state.

However, contrary to the above description, it is also advantageous to match the thresholds between the determination ON state and the determination OFF state. For example, in this drawing, from the viewpoints of only the average light reception amount, “one green light is turned on” in the determination ON state and “three red lights are turned on (or two red lights are turned on)” in the determination OFF state are adjacent to each other. Thus, when the optical axis is shielded and the determination ON state is switched to the determination OFF state while the average light reception amount is maintained, the display pattern is switched from “one green light is turned on” to “three red lights are turned on (or two with red lights turned on)”.

That is, focusing only on the number of turned-on lights, there is a possibility that the display pattern is switched with a sense of discomfort that the number of turned-on lights increases even though the optical axis is shielded. Thus, when a priority is given to the purpose of transmitting the optical axis light reception amount in an easily understandable manner, it can be said that it is desirable to align the thresholds between the determination ON state and the determination OFF state such that a reverse rotation phenomenon of the number of turned-on lights does not occur.

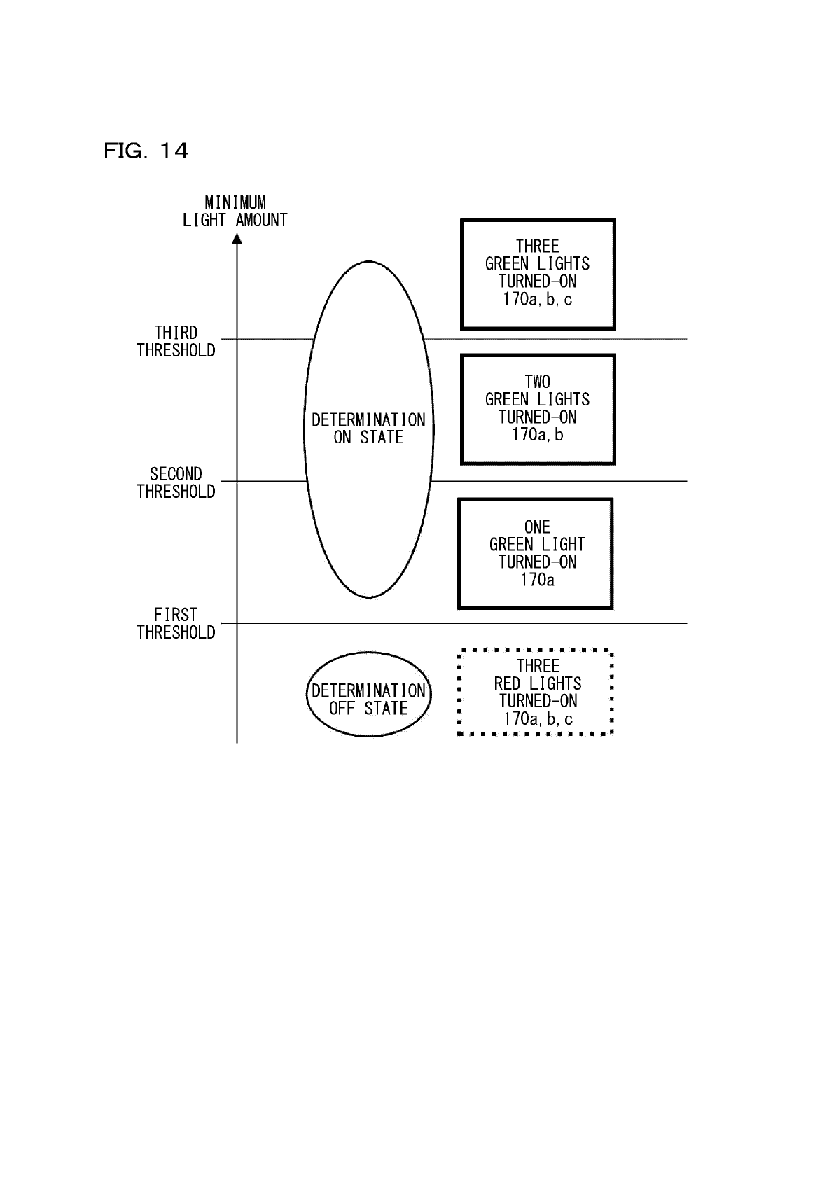

FIG. 14 is a diagram illustrating a relationship between the optical axis light reception amount (minimum light amount) and the display pattern. As illustrated in this drawing, the determination criterion for determining the display pattern may be a minimum value (= minimum light amount) of the light reception amount on each optical axis.

In this case, for example, a first threshold, a second threshold, and a third threshold are set as threshold setting. A relationship between the thresholds may be first threshold < second threshold < third threshold.

With reference to this drawing, when the minimum light amount is lower than the first threshold, three red lights are turned on (= a state where the indicator lamp light sources 170a, 170b, and 170c are turned on in red). This state corresponds to the determination OFF state. As described above, in the determination OFF state, the number of turned-on red lights is fixed to three. When the minimum light amount is higher than the first threshold and lower than the second threshold, one green light is turned on (= a state where only the indicator lamp light source 170a is turned on in green). When the minimum light amount is higher than the second threshold and lower than the third threshold, two green lights are turned on (= a state where the indicator lamp light sources 170a and 170b are turned on in green). When the minimum light amount is higher than the third threshold, three green lights are turned on (= a state where the indicator lamp light sources 170a, 170b, and 170c are turned on in green). That is, as the minimum light amount increases, the number of turned-on green lights increases.

As described above, as the determination criterion for determining the display pattern, an average value (= average light reception amount) of the light reception amounts in the optical axes may be adopted, or the minimum value (= minimum light reception amount) may be adopted.

### Turned-on Image

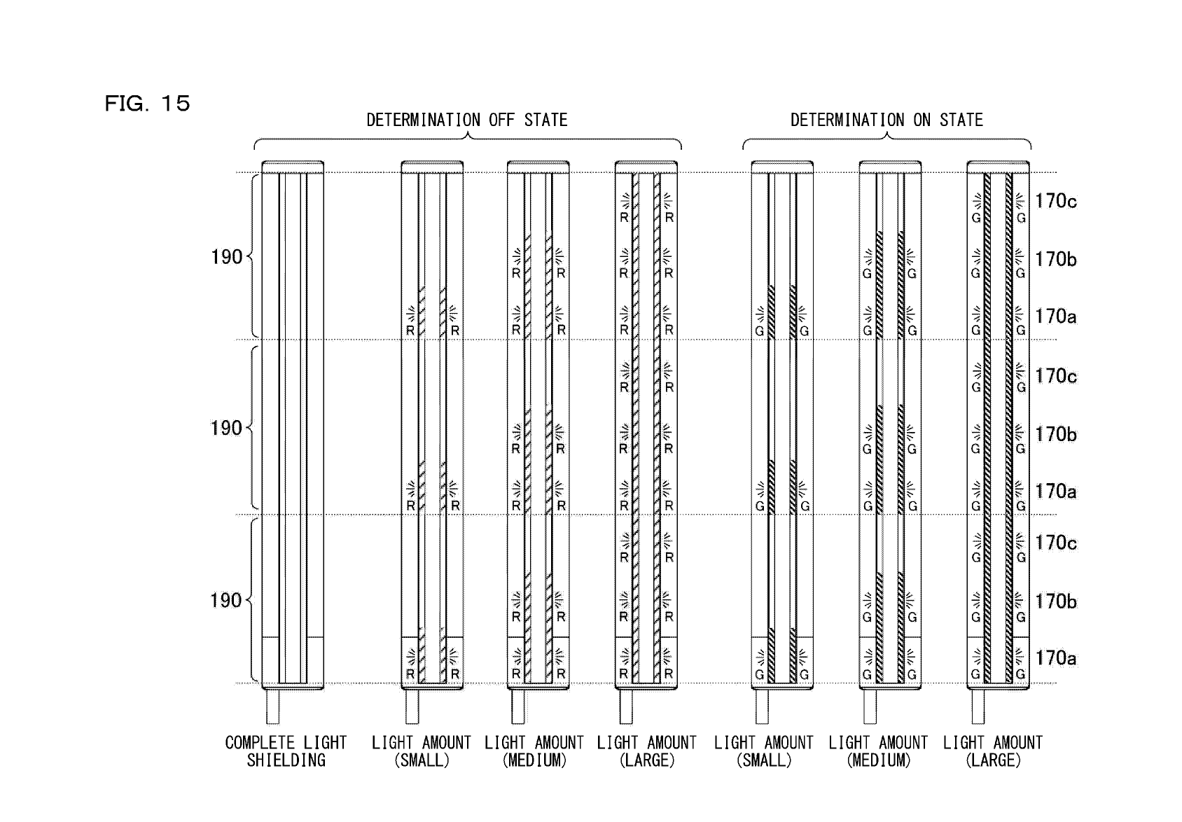

FIG. 15 is a diagram illustrating a turned-on image (first example) of the light curtain 1. In this drawing, the second embodiment described above (FIGS. 9 and 10) is adopted as the arrangement example and the display pattern of the indicator lamp light sources 170a, 170b, and 170c. In addition, for the relationship between the optical axis light reception amount and the display pattern, the switching control of the display pattern described above with reference to FIG. 13 is adopted.

First, the determination OFF state (four states on a left side of this drawing) will be described. In a complete light shielding state, the light curtain 1 is turned off (= a state where the indicator lamp light sources 170a, 170b, and 170c are turned off). In light amount (small), one red light is turned on (= a state where only the indicator lamp light source 170a is turned on in red). In light amount (medium), two red lights are turned on (= a state where the indicator lamp light sources 170a and 170b are turned on in red). In light amount (large), three red lights are turned on (= a state where the indicator lamp light sources 170a, 170b, and 170c are turned on in red).

Next, the determination ON state (three states on a right side of this drawing) will be described. In light amount (small), one green light is turned on (= a state where only the indicator lamp light source 170a is turned on in green). In light amount (medium), two green lights are turned on (= a state where the indicator lamp light sources 170a and 170b are turned on in green). In light amount (large), three green lights are turned on (= a state where the indicator lamp light sources 170a, 170b, and 170c are turned on in green).

Note that, a light diffusing body is arranged above each of the indicator lamp light sources 170a, 170b, and 170c. Thus, it is desirable to appropriately set the arrangement and the display pattern of the indicator lamp light sources 170a, 170b, and 170c such that switching of the display pattern can be recognized also through the light diffusing body. This point is also as described above.

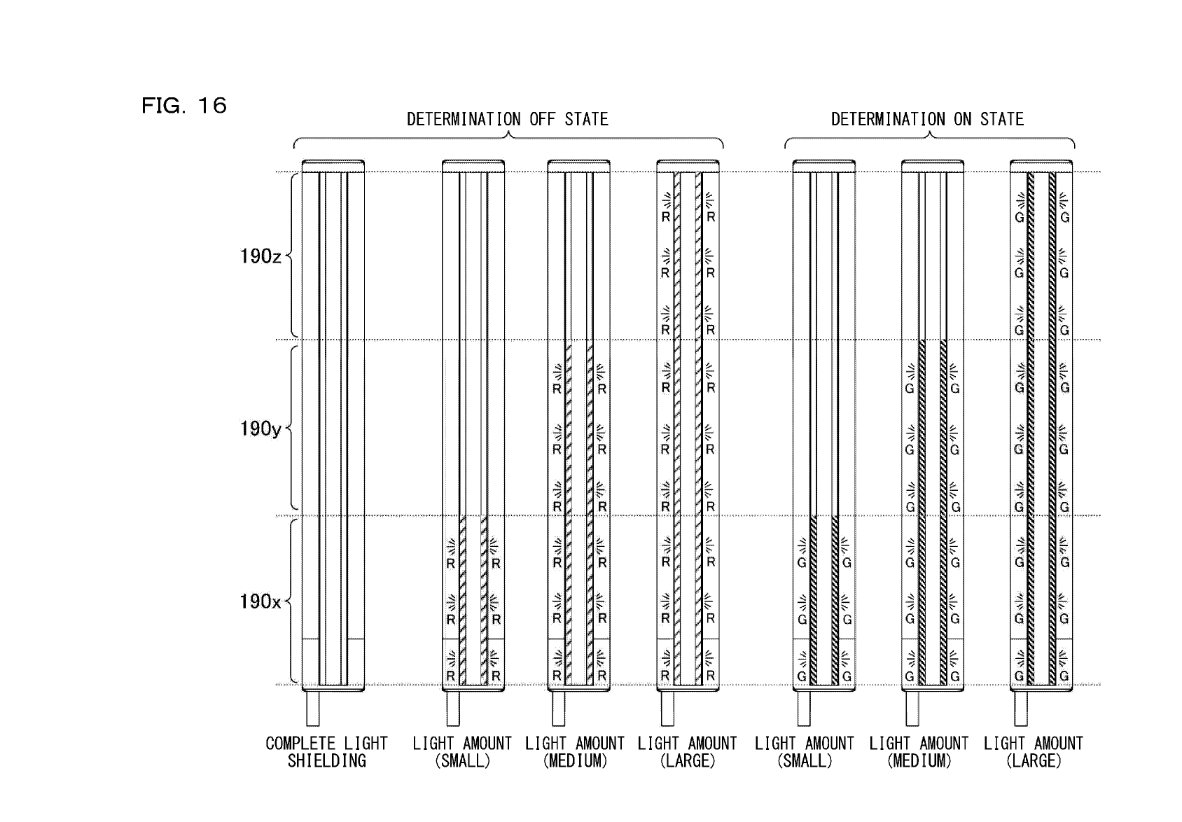

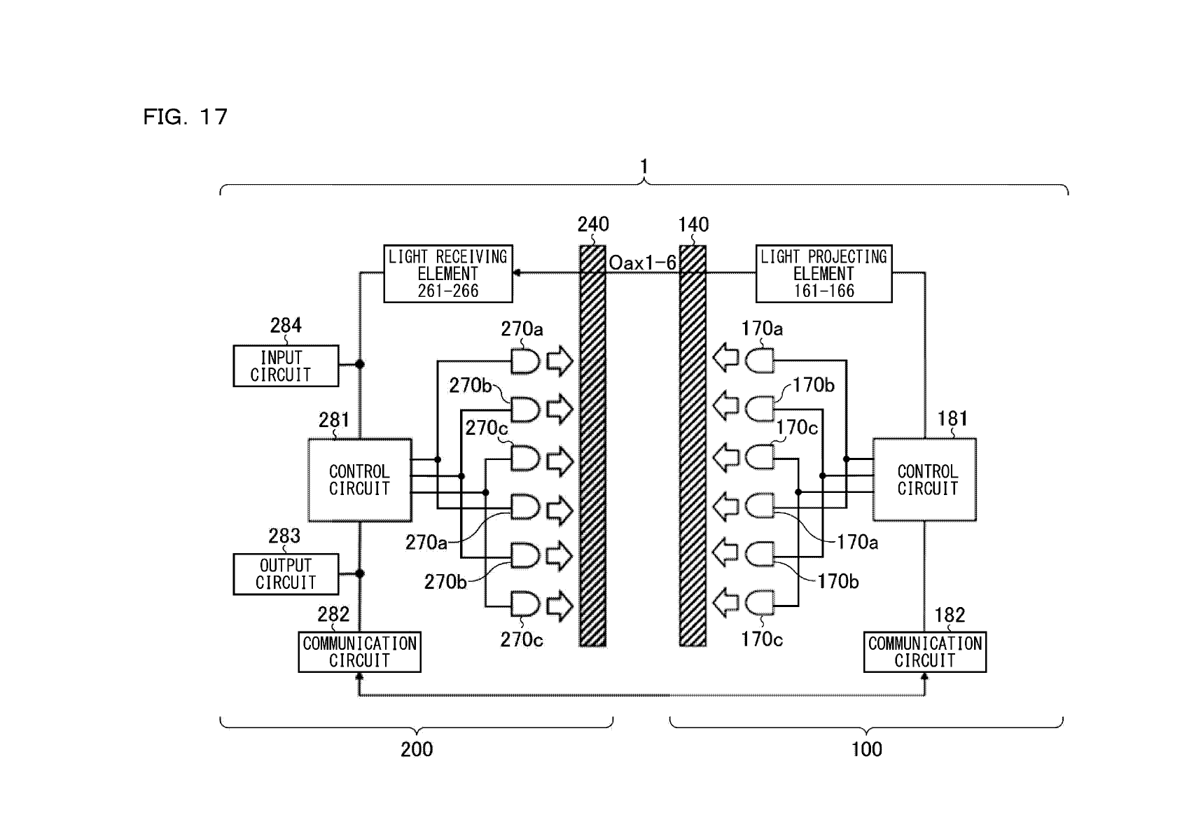

FIG. 16 is a diagram illustrating a turned-on image (second example) of the light curtain 1. In this drawing, bar display of the light curtain 1 corresponding to the optical axis light reception amount is performed. Specifically, each of three substrates 190x, 190y, and 190z cascade-connected in the longitudinal direction of the light curtain 1 (more precisely, a group of indicator lamp light sources 170 incorporated therein) is controlled to be turned on or off as an individual unit.

First, the determination OFF state (four states on a left side of this drawing) will be described. In a complete light shielding state, the light curtain 1 is turned off (= a state where the substrates 190x, 190y, and 190z are turned off). In light amount (small), 1/3 of the light curtain 1 is turned on with a red bar (= only the substrate 190x is turned on in red). In light amount (medium), 2/3 of the light curtain 1 is turned on with a red bar (= a state where the substrates 190x and 190y are turned on in red). In light amount (large), the entire light curtain 1 (3/3) is turned on with a red bar (= a state where the substrates 190x, 190y, and 190z are turned on in red).

Next, the determination ON state (three states on a right side of this drawing) will be described. In light amount (small), 1/3 of the light curtain 1 is turned on with a green bar (= only the substrate 190x is turned on in green). In light amount (medium), 2/3 of the light curtain 1 is turned on with a green bar (= the substrates 190x and 190y are turned on in green). In light amount (large), the entire light curtain 1 (3/3) is turned on with a green bar (= a state where the substrates 190x, 190y, and 190z are turned on in green).

As described above, in the turned-on image of the second example (FIG. 16), the switching of the display pattern corresponding to the optical axis light reception amount is more easily grasped as compared with the above-described first example (FIG. 15). Note that, in a case where the above-described turned-on image is realized based on the configuration in which the plurality of substrates 190x, 190y, and 190z are cascade-connected, a design difficulty level and cost can increase.

### Modification of Display Pattern corresponding to Optical Axis Light Reception Amount

In the above description, the configuration in which the number (in particular, an intermittent interval) of turned-on indicator lamp light sources 170 is switched in accordance with the optical axis light reception amount has been illustrated. However, other various modifications are conceivable.

For example, a temporal change (for example, whether or not to constantly turn on the indicator lamp 140, blink the indicator lamp at intervals of 1 second, or blink the indicator lamp at intervals of 2 seconds) of the indicator lamp 140 may be switched in accordance with the optical axis light reception amount. In addition, for example, a light emission amount or a light emission color of the indicator lamp 140 may be switched in accordance with the optical axis light reception amount. In a case where these aspects are adopted, it is not necessary to individually control the plurality of indicator lamp light sources 170 at the time of switching the display pattern. Thus, for example, an optical guiding fiber can be used as the indicator lamp 140.

### Functional Block (having Display Pattern Control Function)

FIG. 17 is a functional block diagram of the light curtain 1 having a display pattern control function. Note that, in this drawing, with reference to FIG. 5 described above, control systems of the indicator lamp light sources 170a, 170b, and 170c and the indicator lamp light sources 270a, 270b, and 270c are focused instead of light emission and light reception systems of the optical axes Oax1 to Oax6.

In addition, according to the second embodiment (FIGS. 9 and 10) described above, the indicator lamp light sources 170a, 170b, and 170c, and the indicator lamp light sources 270a, 270b, and 270c are arrayed as a set of three in the illustrated order (in the order of a, b, c, a, b, and c from the upper side of this drawing).

The control circuit 181 controls the two indicator lamp light sources 170a by a common control signal. The same applies to the indicator lamp light sources 170b and 170c. In addition, the control circuit 281 controls the two indicator lamp light sources 270a by a common control signal. The same applies to the indicator lamp light sources 270b and 270c.

Note that, the light reception amount of each of the optical axes Oax1 to Oax6 is compared with the threshold in the control circuit 281. In this case, the control circuit 281 may include an analog-to-digital conversion circuit that converts an analog signal output from each of the light receiving elements 261 to 266 into a digital signal. In addition, the control circuit 281 may include an arithmetic circuit that calculates an average value (= average light reception amount) or a minimum value (= minimum light reception amount) from the light reception amount of each of the optical axes Oax1 to Oax6.

The control circuit 281 performs turned-on or turned-off control of each of the indicator lamp light sources 270a, 270b, and 270c based on a comparison result between the average light reception amount (or the minimum light reception amount) and the threshold. In addition, the control circuit 281 transmits the comparison result to the control circuit 181 via the communication circuits 282 and 182. The control circuit 181 performs turned-on or turned-off control of each of the indicator lamp light sources 170a, 170b, and 170c based on the comparison result transmitted from the control circuit 281.

### Processing Flow

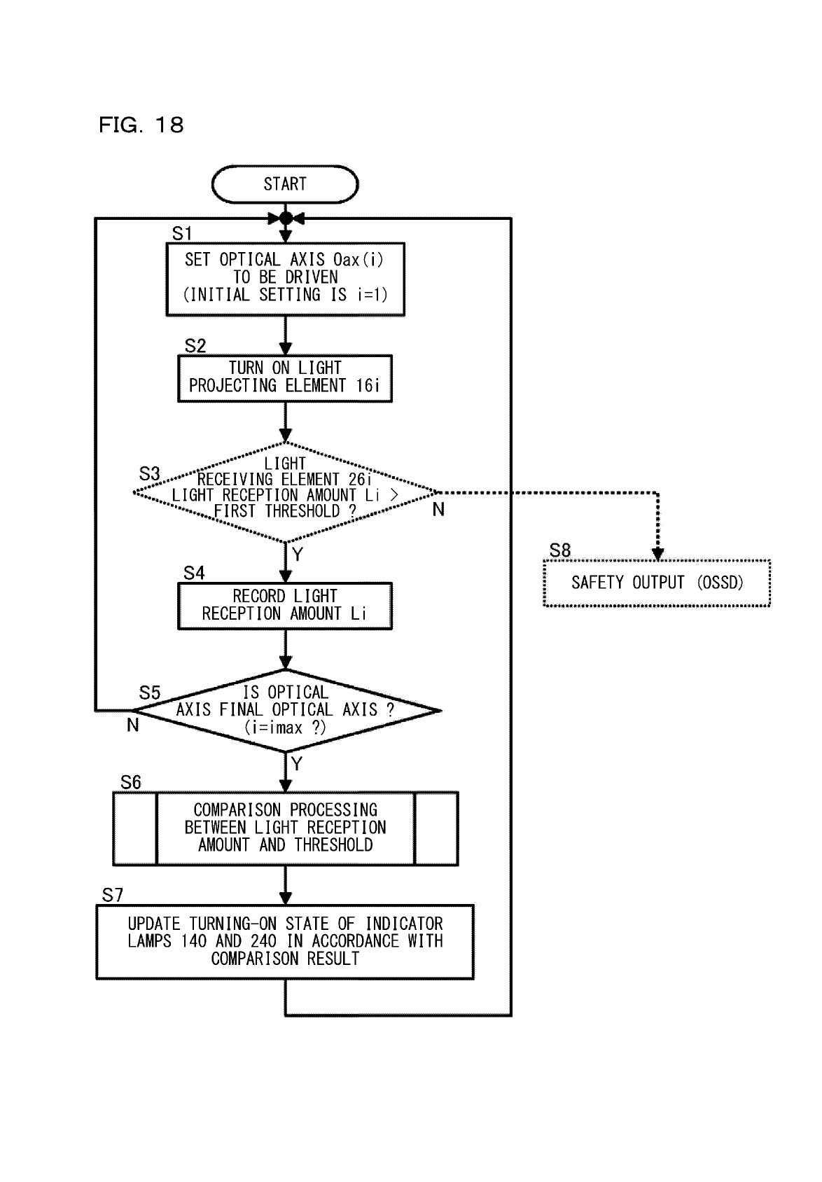

FIG. 18 is a diagram illustrating a processing flow of display pattern control based on the average light reception amount. When the processing flow of this drawing is started, in step S1, the optical axis Oax(i) (where i = 1, 2, ..., and imax(6) and an initial setting value is i = 1) to be driven is set.

In subsequent step S2, the light projecting element 16i is turned on. That is, first, the light projecting element 161 for forming the optical axis Oax1 is turned on.

In step S3, it is determined whether or not a light reception amount Li in the light receiving element 26i is larger than the first threshold. Note that, as described above, the first threshold corresponds to the threshold for determining whether or not each of the optical axes Oax1 to Oax6 is in the light shielding state. Here, in a case where YES determination is made, the flow proceeds to step S4. On the other hand, in a case where NO determination is made, the flow proceeds to step S8. In step S8, the safety output (OSSD) is switched to the OFF state without waiting for completion of the display pattern control. Accordingly, it is possible to promptly stop a dangerous source such as a press machine. In addition, in step S8, in addition to the safety output (OSSD) being switched to the OFF state, the display aspect of the OSSD indicator lamp may be changed in accordance with the safety output (OSSD) being switched to the OFF state. Note that, steps S3 and S8 are not directly related to the display pattern control. Thus, steps S3 and S8 are depicted by broken lines in this drawing.

When YES determination is made in step S3, the light reception amount Li is recorded in a register or the like in step S4.

In subsequent step S5, it is determined whether or not the optical axis is the final optical axis (that is, i = imax(6)). Here, in a case where YES determination is made, the flow proceeds to step S6. On the other hand, in a case where NO determination is made, the flow returns to step S1 after a variable i is incremented by one (++i). Thereafter, steps S1 to S5 are repeated until YES determination is made in step S5.

When YES determination is made in step S5, in step S6, comparison processing between the average value (= average light reception amount) or the minimum value (= minimum light reception amount) of the light reception amounts and the plurality of thresholds is performed. The comparison processing in this step has been described with reference to FIGS. 13 and 14 described above. Thus, the redundant description is omitted.

In subsequent step S7, the turned-on state (display pattern) of each of the indicator lamps 140 and 240 is updated in accordance with the comparison result obtained in step S6. Thereafter, the flow returns to step S1, and the series of processing is repeated.

Note that, this drawing is drawn with the fact that in step S6, comparison processing between the average value (= average light reception) of the light reception amounts and the plurality of thresholds can be performed in mind. That is, the comparison processing in step S6 is not performed for each optical axis, but is performed after the light reception amounts of all the optical axes are recorded.

However, in a case where the comparison processing between the minimum value (= minimum light reception amount) of the light reception amount and the plurality of thresholds is performed, step S5 may be omitted. That is, the comparison processing in step S6 may be sequentially performed for each optical axis at a time without waiting for the light reception amounts of all the optical axes to be recorded.

For example, when the light reception amount obtained by the first light receiving element 261 is the second threshold or less, it is sufficient to switch to one green light (= a state where only the indicator lamp light source 170a is turned on in green) without comparing the light reception amount of each of the other light receiving elements 262 to 266 with the threshold (see FIG. 14). Accordingly, the subsequent comparison processing can be omitted.

### Summary

In FIGS. 9 to 18 described above, the light curtain 1 having the function of switching the display pattern corresponding to the optical axis light reception amount has been proposed. When this configuration is briefly described, it can be expressed as “A light curtain including a housing having a metal case in which one element of a pair of a light projecting element and a light receiving element forming a plurality of optical axes is arranged inside along a longitudinal direction and which extends in the longitudinal direction, and end members connected to both ends of the metal case, in order to form the plurality of optical axes at intervals from each other; a cover that transmits light from the light projecting element and is attached to the housing so as to cross the plurality of optical axes; an indicator lamp that is a light diffusing member, arranged outward from an outer surface of at least one of the cover and the housing along the longitudinal direction, or formed in series with the cover; and an indicator lamp light source that is accommodated inside the housing and that supplies light for display toward the indicator lamp, wherein, when an operation indicator lamp mode is set, the indicator lamp light source performs turned-on or turned-off control in a display pattern corresponding to a light emission color corresponding to an operation state of the light curtain and a light reception amount of the light receiving element”.

### Fifth Embodiment

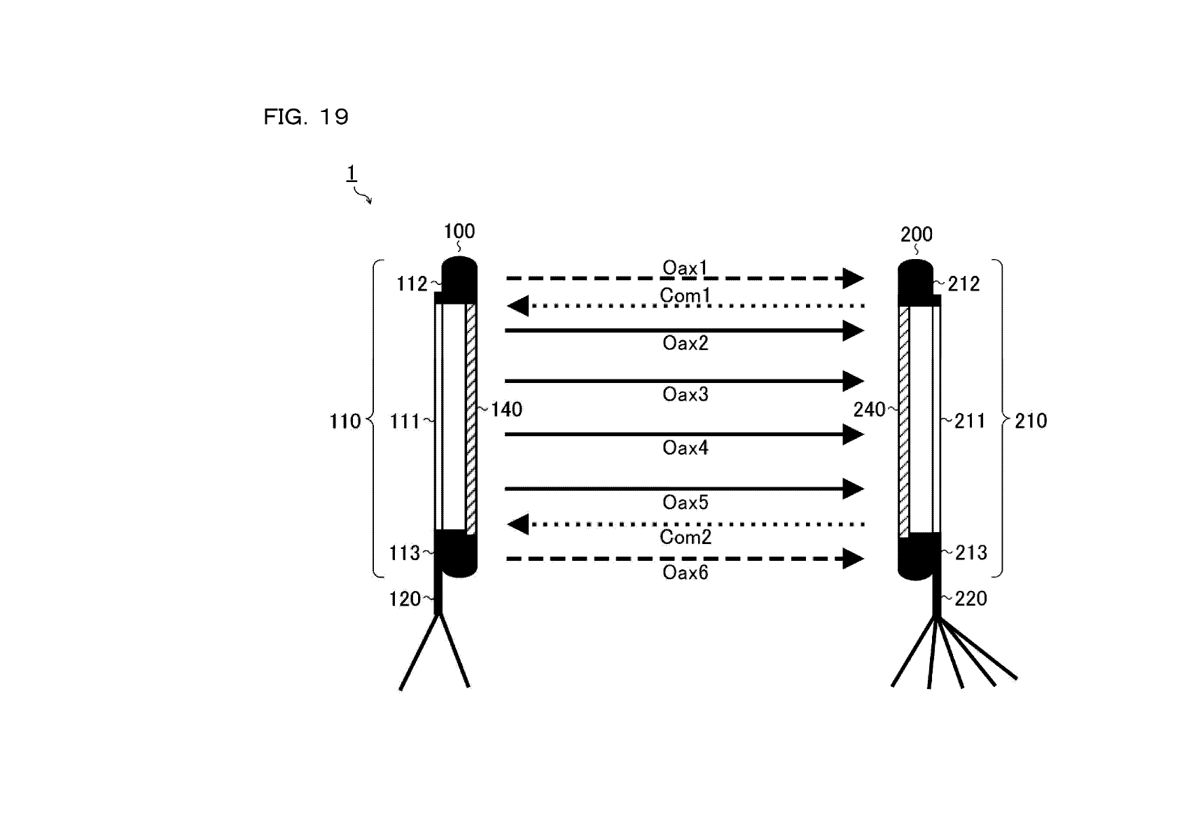

FIG. 19 is a diagram illustrating a configuration example of a light curtain 1 according to a fifth embodiment. The light curtain 1 of the present embodiment includes a pair of a light projector 100 and a light receiver 200.

As described above, the light projector 100 includes a plurality of light projecting elements 161 to 166. In addition, the light receiver 200 is arranged to face the light projector 100, and includes a plurality of light receiving elements 261 to 266 that receive light beams projected from the plurality of light projecting elements 161 to 166. However, in this drawing, only optical axes Oax1 to Oax6 formed between the light projecting elements 161 to 166 and the light receiving elements 261 to 266 are illustrated for the sake of convenience in illustration. The light projecting elements 161 to 166 and the light receiving elements 261 to 266 are described with reference to FIGS. 3 and 5 described above.

The light curtain 1 outputs a safety signal generated based on whether or not each of the plurality of optical axes Oax1 to Oax6 formed between the light projector 100 and the light receiver 200 is in a light shielding state, that is, the OSSD output described above to an outside. It goes without saying that the number of optical axes Oax1 to Oax6 is any number.

In addition, the light curtain 1 includes a synchronization unit that synchronizes a light projection timing of each of the light projecting elements 161 to 166 in the light projector 100 with a light reception timing of each of the light receiving elements 261 to 266 in the light receiver 200 by optical communication. That is, in the light curtain 1, an optical synchronization system is adopted as a synchronization system of the light projection and light reception timings.

With reference to this drawing, among the optical axes Oax1 to Oax6 for light incident and light shielding detection, the optical axes Oax1 and Oax6 formed at both upper and lower ends of the light curtain 1 may be diverted for timing synchronization. For example, the light projector 100 may transmit the synchronization pulse via the optical axis Oax1 before the start of optical axis scan for sequentially detecting the light incident and light shielding of each of the optical axes Oax1 to Oax6. As described above, the synchronization pulse is a pulse signal for timing synchronization and has a unique pulse pattern. The light receiver 200 synchronizes the light reception timing to be matched with the light projection timing of the synchronization pulse.

The optical synchronization system is adopted, and thus, a wiring work between the light projector 100 and the light receiver 200 becomes unnecessary. Accordingly, a degree of freedom in wiring of the light curtain 1 can be increased.

In addition, the light curtain 1 includes indicator lamps 140 and 240. The indicator lamp 140 is provided in the light projector 100. The indicator lamp 240 is provided in the light receiver 200. The indicator lamps 140 and 240 can function as operation indicator lamps for indicating an operation state of the light curtain 1. A worker can visually recognize the operation state of the light curtain 1, for example, a turned-on or turned-off state of the OSSD output by looking at the indicator lamps 140 and 240 of the light curtain 1.

Further, the light curtain 1 includes an interlocking and display unit for interlocking and displaying the indicator lamps 140 and 240 by optical communication from the light receiver 200 to the light projector 100. With reference to this drawing, optical axes Com1 and Com2 for interlocking and display control are formed between the light projector 100 and the light receiver 200 separately from the optical axes Oax1 to Oax6 for light incident and light shielding detection and timing synchronization.

Note that, the optical axes Com1and Com2 may be formed, for example, near both the upper and lower ends of the light curtain 1. With reference to this drawing, the optical axis Com1 is formed between the optical axis Oax1 and the optical axis Oax2. In addition, the optical axis Com2 is formed between the optical axis Oax5 and the optical axis Oax6. However, one of the optical axes Com1 and Com2 may be omitted. In addition, the optical axes Com1 and Com2 may be formed in upper and lower central regions of the light curtain 1.

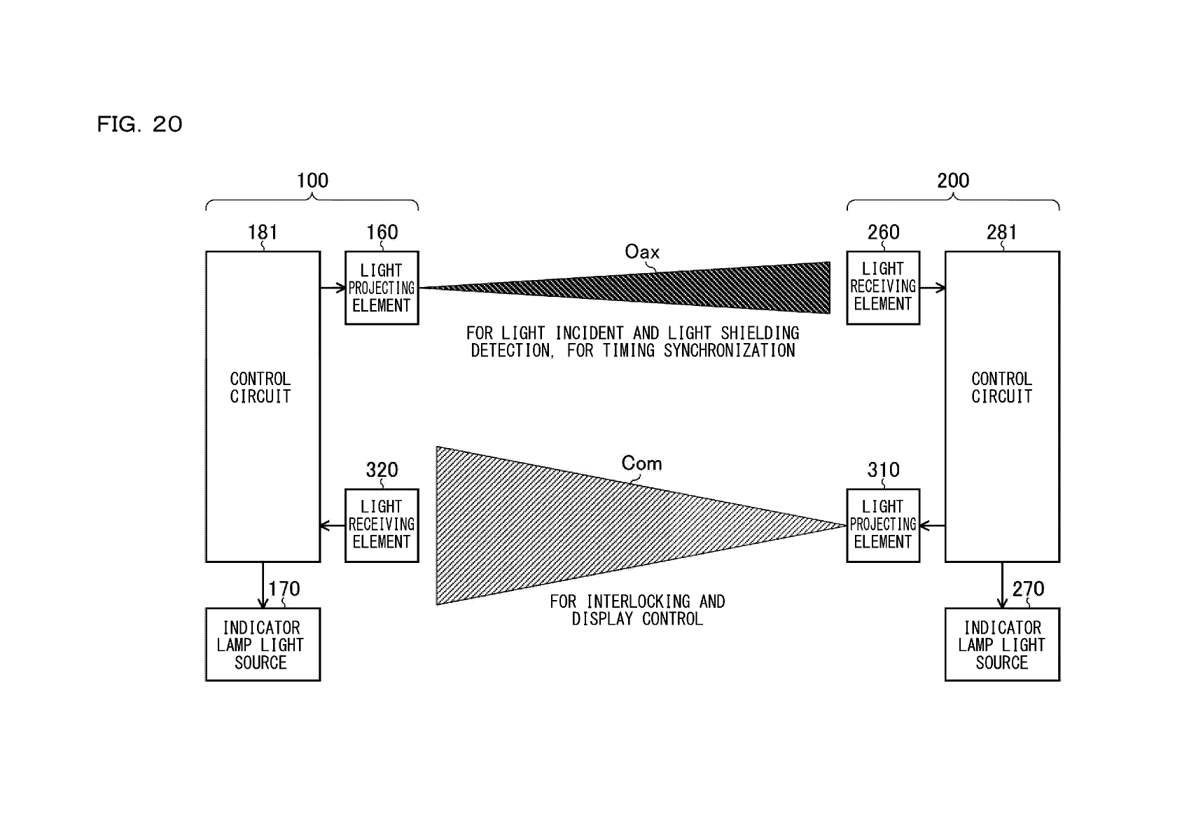

FIG. 20 is a schematic diagram illustrating an example of optical axis formation. As illustrated in this drawing, the light curtain 1 of the present embodiment includes at least a pair of a light projecting element 160 and a light receiving element 260 provided for interlocking and display control of the indicator lamps 140 and 240, separately from at least a pair of a light projecting element 310 and a light receiving element 320 provided for light incident and light shielding detection. In addition, in this drawing, the control circuits 181 and 281 described above are illustrated as units for integrating an overall operation of each of the light projector 100 and the light receiver 200.

The light projecting element 160 is an optical element provided in the light projector 100. The light projecting element 160 may be understood as the light projecting elements 161 to 166 described above. The light projecting element 160 may be, for example, a light emitting diode. The light receiving element 260 is an optical element provided in the light receiver 200. The light receiving element 260 can be understood as the light receiving elements 261 to 266 described above. The light receiving element 260 may be, for example, a photodiode or a phototransistor. An optical axis Oax for light incident and light shielding detection or timing synchronization is formed between the light projecting element 160 and the light receiving element 260. The optical axis Oax corresponds to the optical axes Oax1 to Oax6 described above.

The light projecting element 310 is an optical element provided in the light receiver 200. The light projecting element 310 may be, for example, a light emitting diode. The light receiving element 320 is an optical element provided in the light projector 100. The light receiving element 320 may be, for example, a photodiode or a phototransistor. An optical axis Com for interlocking and display control different from the optical axis Oax is formed between the light projecting element 310 and the light receiving element 320. The optical axis Com corresponds to the optical axes Com1 and Com2 described above.

The control circuits 181 and 281 interlock and display the indicator lamps 140 and 240 by performing optical communication for interlocking and display control by using the optical axis Com formed between the light projecting element 310 and the light receiving element 320. Note that, the optical axis Com can be understood as an optical communication path from the light receiver 200 to the light projector 100.

For example, the control circuit 281 of the light receiver 200 determines the turned-on or turned-off state of the OSSD output depending on whether or not the optical axis Oax formed between the light projecting element 160 and the light receiving element 260 is in the light shielding state. Then, the control circuit 281 performs turned-on or turned-off control of the indicator lamp light source 270 in accordance with the turned-on or turned-off state of the OSSD output. At this time, the control circuit 281 drives the light projecting element 310 to transmit the turned-on or turned-off state of the OSSD output to the light projector 100. The control circuit 181 of the light projector 100 performs the turned-on or turned-off control of the indicator lamp light source 170 in accordance with turned-on or turned-off information of the OSSD output received by the light receiving element 320.

In the light curtain 1 of the present embodiment, the indicator lamps 140 and 240 can be interlocked and displayed without requiring the wiring work between the light projector 100 and the light receiver 200. Accordingly, the visibility of the indicator lamps 140 and 240 can be enhanced while enjoying the advantages of the optical synchronization system.

Note that, as described above, the optical axis Com for interlocking and display control may be formed as a dedicated optical axis separately from the optical axis Oax for light incident and light shielding detection or timing synchronization. With this configuration, a degree of freedom in designing each of the light projecting element 310 and the light receiving element 320 is increased. In addition, in a configuration in which the optical axis Oax and the optical axis Com are individually formed, a degree of freedom in design such as the number of light projection pulses or a pulse interval increases.

For example, for the optical axis Oax for light incident and light shielding detection, in order to accurately detect the light shielding state, a light projection spread angle of the light projecting element 160, a light receiving viewing angle of the light receiving element 260, a size of a lens provided in a light guide path of each of the light projecting element 160 and the light receiving element 260, and the like can be strictly limited by safety standards.

On the other hand, the above-described limitation is not imposed on the optical axis Com for interlocking and display control. Thus, for example, the light projecting element 310 may be designed to have a larger light projecting spread angle than the light projecting element 160. In addition, the light receiving element 320 may be designed to have a larger light receiving viewing angle than the light receiving element 260. Further, a size of a lens provided in the light guide path of each of the light projecting element 310 and the light receiving element 320 may be designed to be larger than the size of the lens provided in the light guide path of each of the light projecting element 160 and the light receiving element 260.

According to such a design, the optical axis Com is easily established between the light projector 100 and the light receiver 200. Accordingly, for example, when optical axis alignment is performed in an installation work of the light curtain 1, interlocking and display of the indicator lamps 140 and 240 can be quickly performed. As a result, since state display (see FIGS. 13 or 14) interlocked with the optical axis light reception amount described above can be performed, the optical axis alignment can be easily performed.

Note that, for example, in FIG. 5 described above, when at least one pair of the light projecting element and the light receiving element, among the light projecting elements 161 to 166 and the light receiving elements 261 to 266, is exchanged between the light projector 100 and the light receiver 200, it is not impossible to use one optical axis for both the light incident and light shielding detection and the interlocking and display control in a time division manner. According to the present modification, since the light projecting element 310 and the light receiving element 320 are omitted, which can contribute to cost reduction of the light curtain 1. However, at least one piece of light incident and light shielding information of the optical axes Oax1 to Oax6 is obtained not by the light receiver 200 but by the light projector 100. Accordingly, in order to output the OSSD by the light receiver 200, optical communication for transmitting the light incident and light shielding information obtained by the light projector 100 to the light receiver 200 is also required.

In addition, a plurality of sets of the light projecting element 310 and the light receiving element 320 may be provided. For example, as illustrated in FIG. 19 described above, a plurality of optical axes Com1 and Com2 may be formed for interlocking and display control. With this configuration, even though one of the optical axes Com1 and Com2 is shielded, information transmission from the light receiver 200 to the light projector 100 can continue.

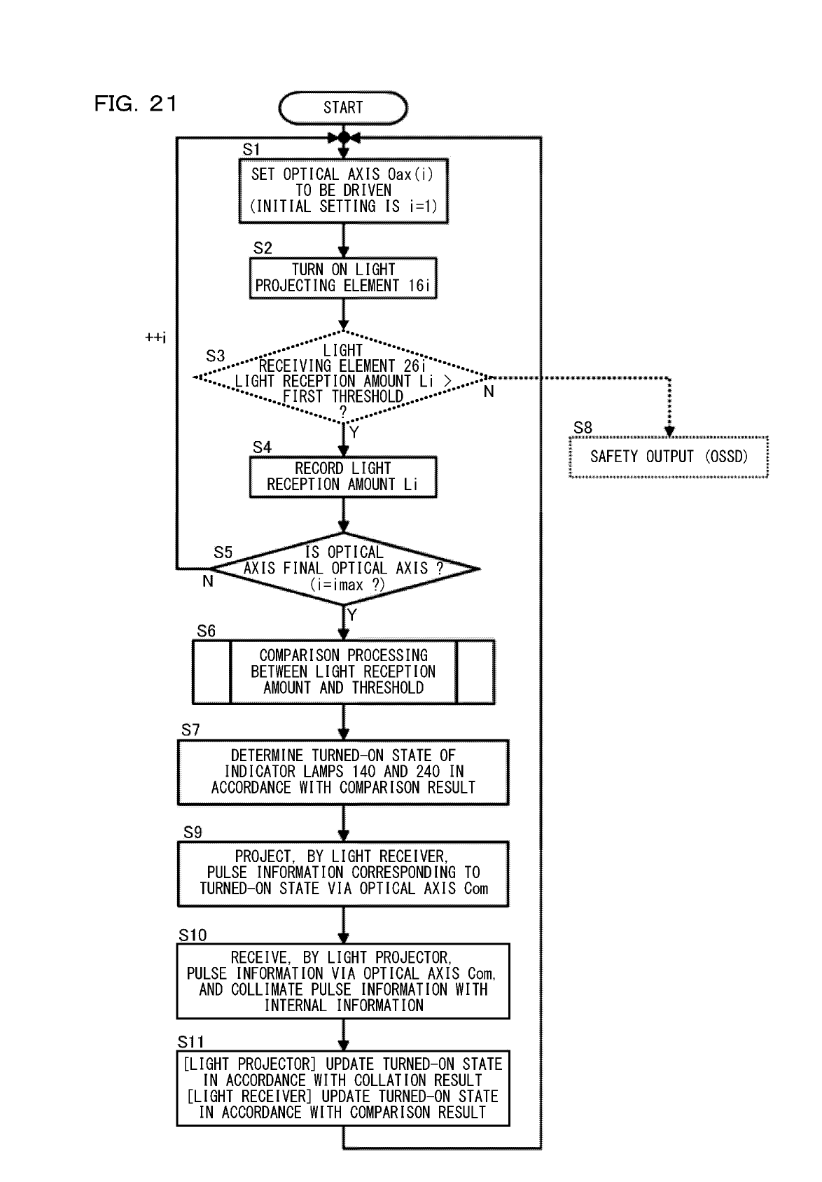

FIG. 21 is a diagram illustrating a processing flow of the interlocking and display control. In the processing flow of this drawing, the operation in step S7 is changed and steps S9 to S11 are added subsequently step S7 to FIG. 18 described above. Hereinafter, processing contents after step S7 and subsequent steps will be mainly described.

In step S7, the light receiver 200 determines a turned-on state (display pattern) of each of the indicator lamps 140 and 240 in accordance with the comparison result obtained in step S6. Thereafter, the flow proceeds to step S9 without being returned to step S1.

In step S9, the light receiver 200 performs pulse drive of the optical axis Com to project pulse information corresponding to the turned-on state (display pattern) determined in step S7. That is, after light incident and light shielding states of all the optical axes Oax(i) are detected, the light receiver 200 performs optical communication reflecting the detection result. The above pulse information may be, for example, a specific pulse pattern.

Thereafter, in step S10, the light projector 100 receives the pulse information via the optical axis Com and collates the pulse information with predetermined internal information. Note that, the internal information may be a table that associates the pulse information with the turned-on or turned-off state of the indicator lamp 140.

In subsequent step S11, the light projector 100 updates the turned-on state (display pattern) of the indicator lamp 140 in accordance with the collation result in step S10, that is, the determination content in step S7. In addition, the light receiver 200 updates the turned-on state (display pattern) of the indicator lamp 240 in accordance with the comparison result in step S6 and the determination content in step S7. By such control, the interlocking and display of the indicator lamps 140 and 240 can be realized.

Note that, after the turned-on state (display pattern) of each of the indicator lamps 140 and 240 is updated, the flow returns to step S1, and the series of processing is repeated.

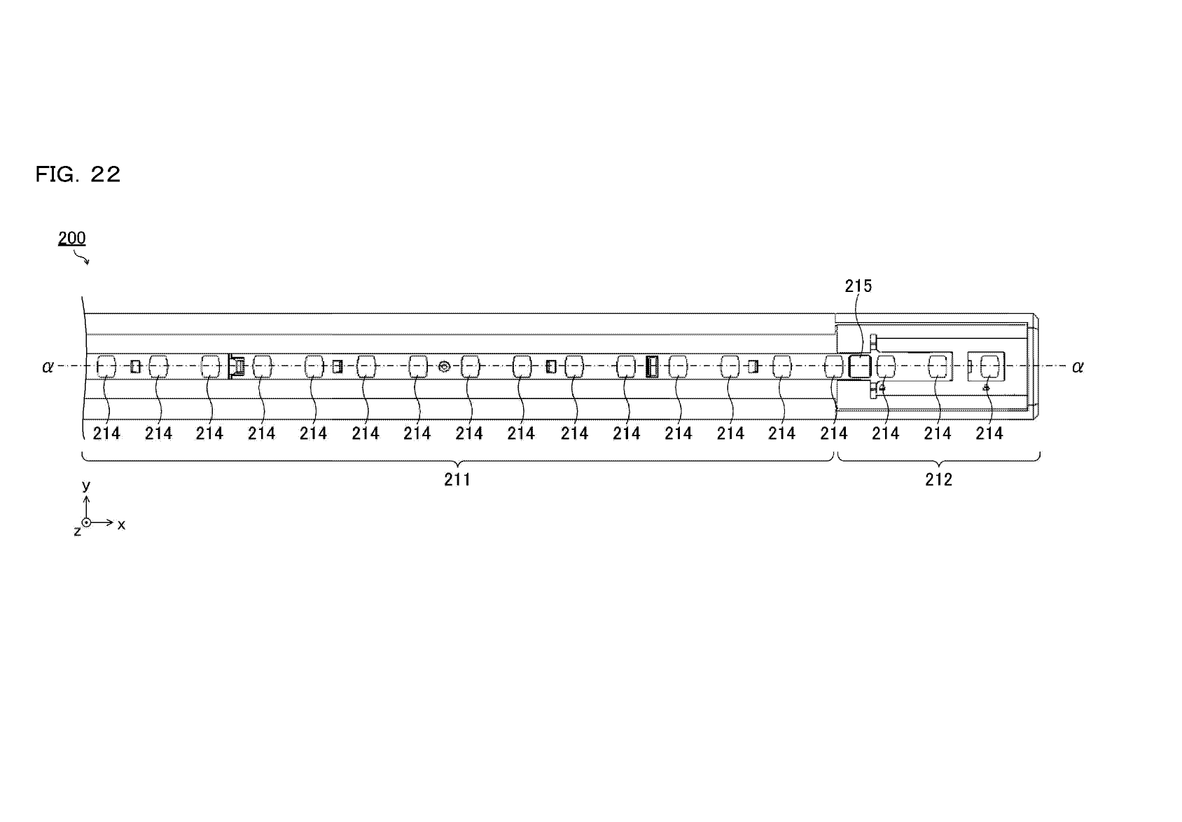

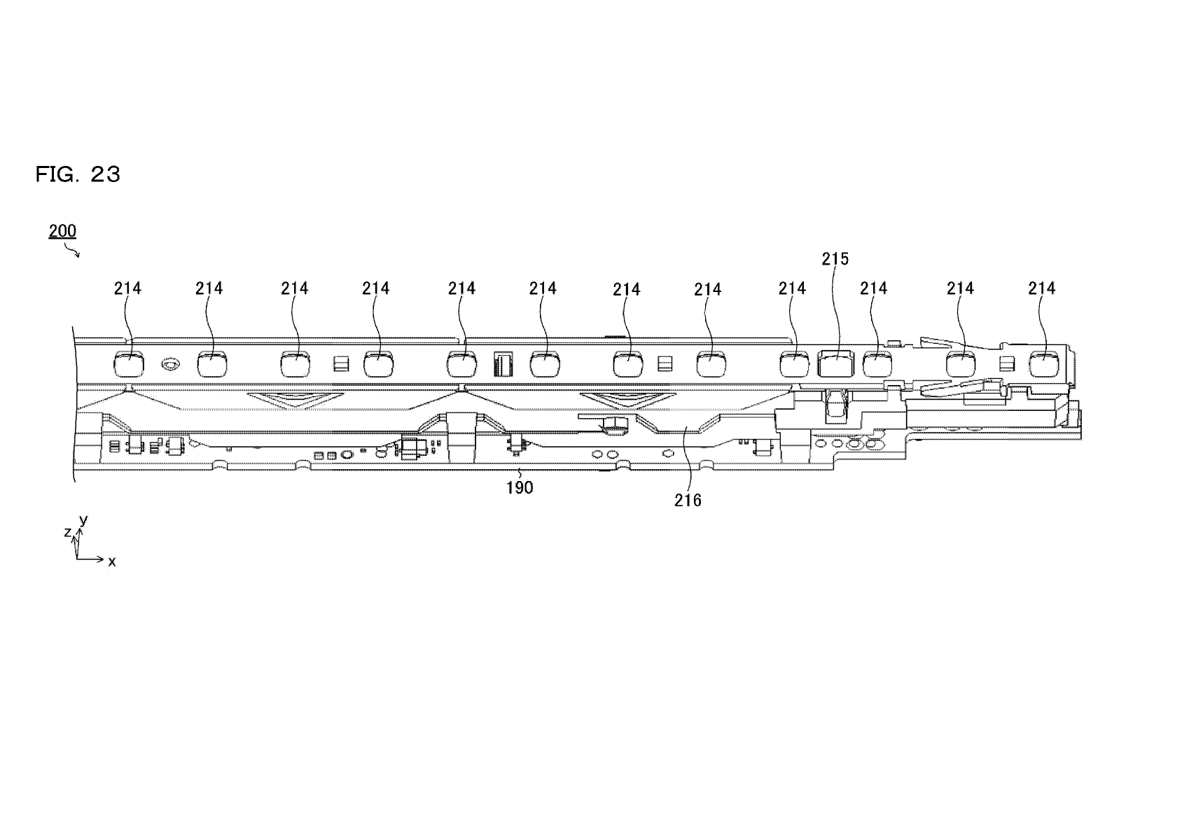

FIGS. 22 and 23 are a plan view and a perspective view illustrating a configuration example of the light receiver 200. In both drawings, a longitudinal direction of the light receiver 200 is an x-axis, a lateral direction is a y-axis, and a thickness direction (depth direction) is a z-axis.

FIG. 22 can be understood as an xy plan view of the light receiver 200 viewed from a front side. In addition, FIG. 23 can be understood as a perspective view in which the light receiver 200 is slightly rotated around the x-axis in such a manner that the z-axis of FIG. 22 is inclined toward a back side of the drawing.

However, FIG. 23 illustrates a state where a metal case 211 and an end cap 212 of the light receiver 200 are removed. Accordingly, FIG. 23 depicts a substrate 190 and a holder 216 accommodated within the metal case 211 and the end cap 212.

As illustrated in both the drawings, a plurality of lenses 214 are arrayed at equal intervals along a longitudinal direction of the light receiver 200 on a front surface of the light receiver 200. Each of the plurality of lenses 214 forms a light guide path (light reception path) of the optical axis Oax. All of the plurality of lenses 214 are carried by the holder 216. Note that, among the plurality of lenses 214, some lenses 214 may be provided at positions corresponding to a front surface of the end cap 212.

In addition, among the plurality of lenses 214, a lens 215 may be provided between two adjacent lenses 214. The lens 215 forms a light guide path (light projection path) of the optical axis Com. The lens 215 is carried by the holder 216. The optical axis Com may be formed, for example, near both ends of the light curtain 1. In view of this drawing, the lens 215 is provided at a position corresponding to the front surface of the end cap 212. A size of the lens 215 may be designed to be larger than a size of each of the plurality of lenses 214.

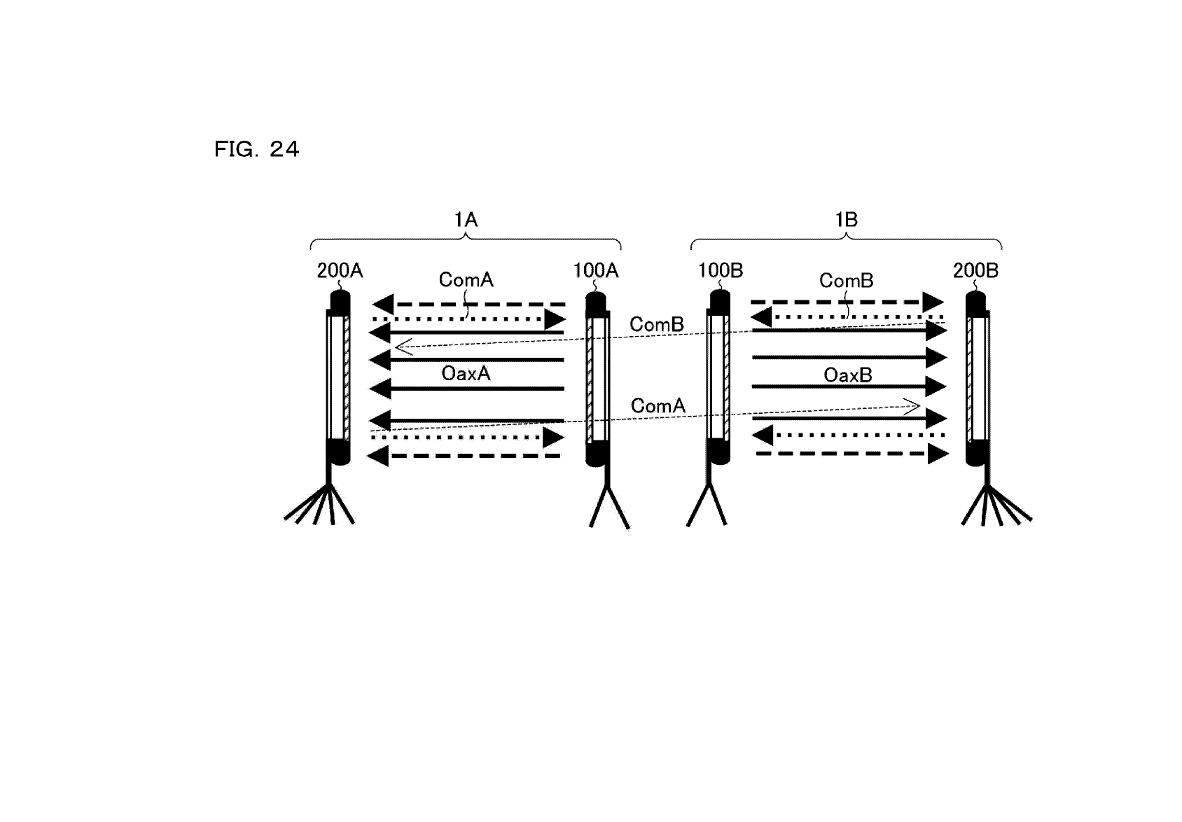

FIG. 24 is a diagram illustrating an example of light mutual interference between a light curtain 1A and a light curtain 1B. The light curtain 1A includes a pair of a light projector 100A and a light receiver 200A. The light curtain 1B includes a pair of a light projector 100B and a light receiver 200B.

The light curtains 1A and 1B are installed such that the light projector 100A of the light curtain 1A and the light projector 100B of the light curtain 1B are back-to-back with each other. From another point of view, the light curtains 1A and 1B are installed such that the light receiver 200A of the light curtain 1A and the light receiver 200B of the light curtain 1B face each other.

With such an installation, an optical axis OaxA emitted from the light projector 100A of the light curtain 1A is less likely to be received by the light receiver 200B of the light curtain 1B. In addition, an optical axis OaxB emitted from the light projector 100B of the light curtain 1B is less likely to be received by the light receiver 200A of the light curtain 1A.

However, as described above, in the light curtains 1A and 1B, the light receiver 200A of the light curtain 1A and the light receiver 200B of the light curtain 1B face each other. Thus, an optical axis ComA emitted from the light receiver 200A of the light curtain 1A can be received by the light receiver 200B of the light curtain 1B. In addition, an optical axis ComB emitted from the light receiver 200B of the light curtain 1B can be received by the light receiver 200B of the light curtain 1A. Accordingly, there is a possibility that trouble is caused in light incident and light shielding detection of the optical axes OaxA and OaxB.

In view of the above consideration, optical axis drive control capable of suppressing the light mutual interference is proposed below.

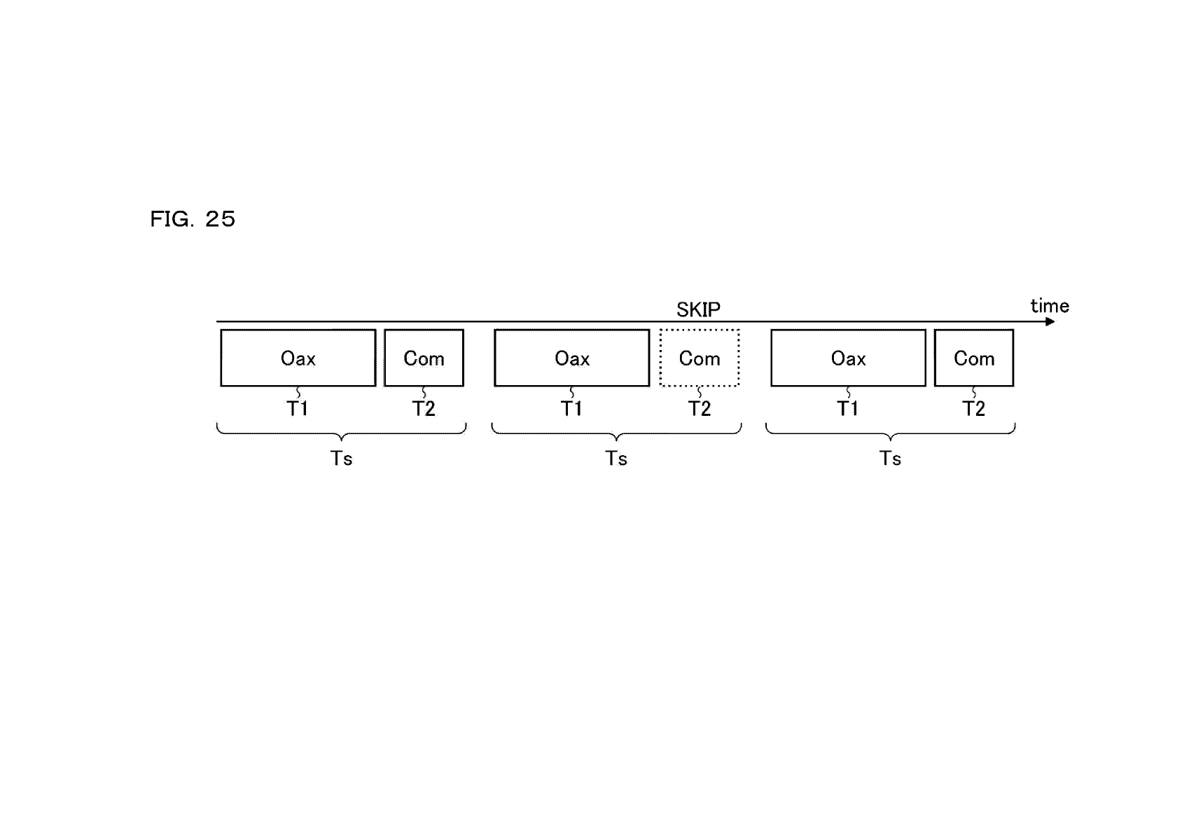

FIG. 25 is a diagram illustrating an example of the optical axis drive control. As illustrated in this drawing, the light curtain 1 of the present embodiment repeats drive periods T1 and T2 in a time division manner, as drive control of the optical axes Oax and Com. The optical axis Oax may be understood as any of the optical axes OaxA and OaxB described above. The optical axis Com may be understood as any of the optical axes ComA and ComB described above.

The drive period T1 can be understood as a period in which the light projecting element 160 and the light receiving element 260 are driven, that is, a period in which the optical axis Oax is formed between the light projecting element 160 and the light receiving element 260 and the light incident and light shielding is detected. The drive period T1 can have a length depending on the number i of optical axes Oax, for example, several ms (= several tens of μs × i).

The drive period T2 can be understood as a period in which the light projecting elements 310 and 320 are driven, that is, a period in which the optical axis Com is formed between the light projecting element 310 and the light receiving element 320 and the pulse information for interlocking and display control is transmitted. The drive period T2 can have a length depending on an information amount to be transmitted, for example, several hundred μs.

In addition, as illustrated in this drawing, one scan period Ts may include the drive periods T1 and T2. However, the drive period T2 may be skipped at a frequency of once with respect to two or a plurality of scan periods Ts. That is, the optical communication using the optical axis Com may be performed after the light incident and light shielding detection of the optical axis Oax is repeated twice or a plurality of times. In other words, an interval of optical communication may be set to be longer than an interval of optical axis detection.

In this case, since a frequency of interference of the optical axis Com with respect to the detection of the optical axis Oax is once or less every two times, the light receiver 200 may operate to ignore the influence of the interference of the optical axis Com.

According to this control, it is possible to suppress the light mutual interference that may occur between the light curtain 1A and the light curtain 1B even under a situation illustrated in FIG. 24.

Note that, in this drawing, for the sake of convenience in description, the skipped drive period T2 is depicted by a broken line frame. Thus, a length of the scan period Ts seems to be constantly constant regardless of whether or not the drive period T2 is skipped. Actually, the scan period Ts may be shortened by the skipped drive period T2 such that a next drive period T1 arrives earlier.

According to such optical axis drive control, it is possible to realize the interlocking and display control of the indicator lamps 140 and 240 while maintaining a response time of the OSSD output as short as possible. Note that, a skip frequency of the drive period T2 only influences a response time of each of the indicator lamps 140 and 240, that is, an update frequency of the turned-on or turned-off state. Accordingly, the skip frequency of the drive period T2 can be designed relatively freely.

In addition, as another method for suppressing the light mutual interference, the optical axes Oax and Com may be different wavelengths. For example, the optical axis Oax may be formed by infrared light, and the optical axis Com may be formed by red light. In this case, a lens that guides the optical axis Com to the light receiving element 320 of the light projector 100 may be subjected to filter processing for cutting infrared light. According to this configuration, the entrance of the optical axis Oax into the light receiving element 320 can be suppressed.

### Non-Establishment of Optical Communication

Meanwhile, in a case where a specific pulse pattern is not received by the light receiving element 320 due to light shielding of the optical axis Com or the like, the optical communication using the optical axis Com cannot be established. In addition, even in a case where an unexpected pulse pattern is received by the light receiving element 320 due to the light mutual interference or the like, the optical communication using the optical axis Com may not be established.

In a case where the optical communication via the optical axis Com is not established in the drive period T2, the light projector 100 falls into a state where the light incident and light shielding state of the light receiver 200 cannot be known. In such a case, the indicator lamp 140 may be maintained in the display state so far. According to such control, when the optical communication is temporarily not established, the interlocking and display of the indicator lamps 140 and 240 is less likely to be disturbed.

However, when the optical communication via the optical axis Com is not established continuously over a plurality of drive periods T2, the indicator lamp 140 may be switched to the turned-off state. According to such control, it is possible to notify the worker that the optical communication is not established. By switching to the turned-off state, it is possible to directly notify the user of the fact that the optical communication of the optical axis Com is not established.

In addition, in a case where the optical axis Com is arranged between the optical axis Oax(i) and the optical axis Ox(i+1), it is unlikely that only the optical axis Com is shielded. Thus, when the optical communication via the optical axis Com is not established continuously over the plurality of drive periods T2, the indicator lamp 140 may be switched to a display state indicating the turned-off state of the OSSD output, for example, a red light turned-on state. However, when the light curtain is aligned with the optical axis, in a case where the light curtain is in the red light turned-on state when the optical communication of the optical axis Com is not established, there is a possibility that the user is confused around the meaning of red. Thus, as described above, it is preferable to switch to the turned-off state when the optical communication of the optical axis Com is not established. Note that, the indicator lamp 140 may blink in green at the time of interlocking (the user can easily grasp an interlocked state by blinking in green instead of lighting in green), or may be turned on in orange at the time of muting. In addition, since information of the indicator lamp 140 is unsafety information, the optical communication non-establishment of the optical axis Com is allowed. In other words, even though the optical communication of the optical axis Com is not established, the OSSD is not turned off.

In a case where the light projector and the light receiver are added in series, the indicator lamp 140 may be independently operated alone. Specifically, for example, in a case where three light projectors (light receivers) are connected in series, when the optical communication of the optical axis Com in the middle light projector (light receiver) is not established, only the middle light projector (light receiver) may be caused to perform a non-established operation (for example, switching to the turned-off state may be performed). All the indicator lamps 140 may be operated in accordance with a predetermined optical communication state of the optical axis Com in the light projector (light receiver) in addition to an independent operation of each unit. For example, in a case where three light projectors (light receivers) are connected in series, when the optical communication of one predetermined optical axis Com is not established, all the indicator lamps 140 may be switched to the turned-off state.

In addition, as described above, two optical axes Com according to the present embodiment are provided for one light projector (light receiver). In a case where pieces of information of the two optical axes Com do not match, it is conceivable to switch to various turned-on states. For example, in a case where only one of the optical axes Com is established, the indicator lamp 140 may be switched based on the information of the established optical axis Com. In addition, for example, in a case where both the optical axes Com are established but the pieces of information of the optical axes Com do not match, a previous state of the indicator lamp 140 may be maintained.

### Light Leakage

Note that, in a case where the optical axis Oax for light incident and light shielding detection and the optical axis Com for interlocking and display control are provided adjacent to each other, light leakage via the light guide paths of the optical axes Oax and Com may occur.

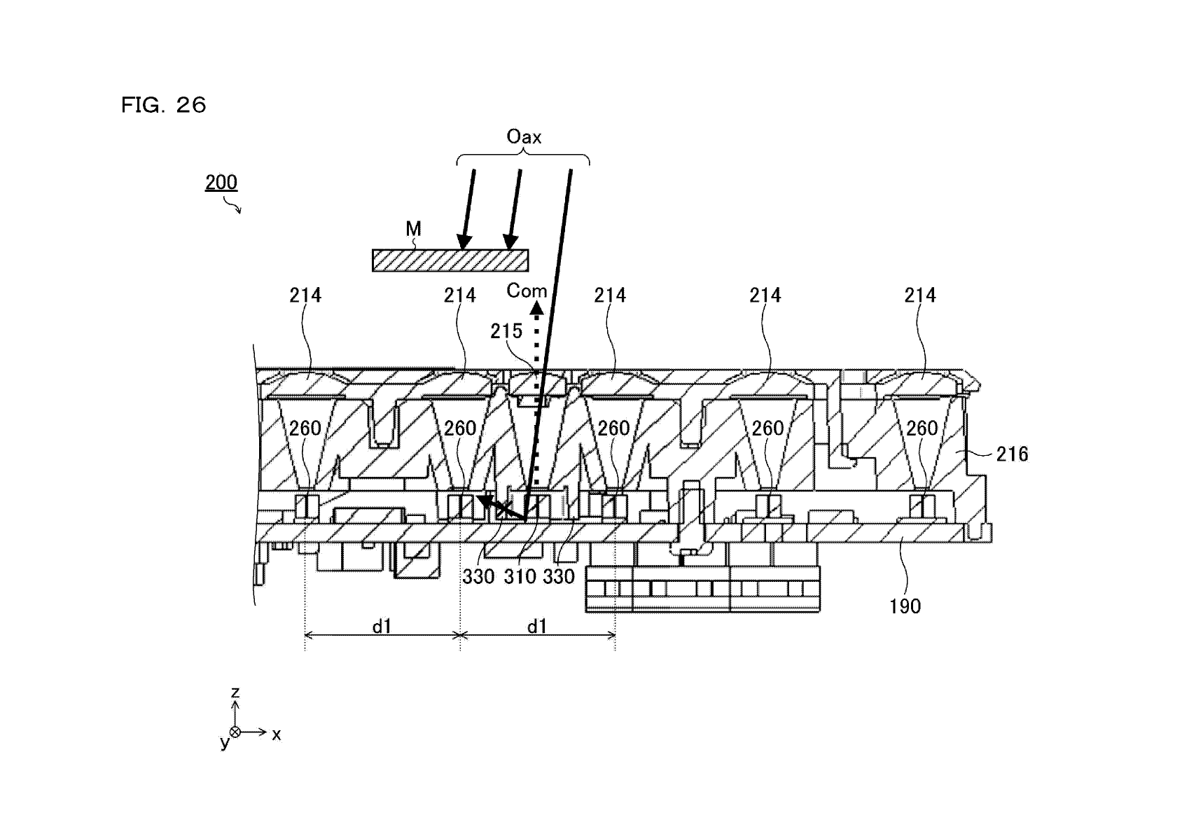

FIG. 26 is a longitudinal sectional view illustrating an example of the light receiver 200 including a suppression mechanism of the light leakage. This drawing can be understood as a diagram illustrating an α-α section in FIG. 22 described above, in particular, a diagram in which a periphery of the lens 215 is partially enlarged.

In the light receiver 200 of the present configuration example, the plurality of light receiving elements 260 are arrayed on a surface of the substrate 190 at a constant interval d1 along the longitudinal direction of the light receiver 200. Each of the plurality of light receiving elements 260 can be understood as an optical element for detecting the optical axis Oax incident from an outside of the light receiver 200 through the plurality of lenses 214.

In addition, on the surface of the substrate 190, the light projecting element 310 is provided between two adjacent light receiving elements 260. The light projecting element 310 can be understood as an optical element for emitting the optical axis Com for the interlocking and display control to the outside of the light receiver 200 via the lens 215.

In this case, as indicated by a solid arrow in this drawing, the light leakage of the optical axis Oax may occur in a form of entering in an opposite orientation from the light guide path of the light projecting element 310 and going around the light receiving element 260. In a case where such light leakage occurs, erroneous detection of the optical axis Oax may occur in the light receiving element 260 adjacent to the light projecting element 310. Specifically, although the optical axis Oax to be incident on the light receiving element 260 is shielded by an object M, the incident light is erroneously detected. In such a situation, since a correct OSSD output is not generated, a very dangerous state may occur.

Therefore, the light receiver 200 of the present configuration example includes a light shielding wall 330. The light shielding wall 330 is formed to shield the light that goes around the light receiving element 260 from the light guide path of the light projecting element 310. For example, the light shielding wall 330 may be formed so as to surround a periphery of the light projecting element 310. With this configuration, the light leakage of the optical axis Oax is suppressed. Accordingly, it is possible to improve the reliability of the light curtain 1 by reducing the erroneous detection of the optical axis Oax in the light receiving element 260.

Note that, the light shielding wall 330 may be integrally formed as a part of the holder 216. Alternatively, the light shielding wall 300 may be formed as an additional part attached to the holder 216.

In addition, the light shielding wall 330 and peripheral components thereof may be less likely to reflect the optical axis Oax as much as possible. For example, the substrate 190 and the holder 216 are desirably blackened.

In addition, as another method of suppressing the light leakage, the optical axes Oax and Com may be different wavelengths as in the method for suppressing the light mutual interference. For example, the optical axis Oax may be formed by infrared light, and the optical axis Com may be formed by red light. In this case, the lens 215 that guides the optical axis Com to the outside of the light receiver 200 may be subjected to filter processing for cutting infrared light. According to this configuration, the entry of the optical axis Oax through the lens 215 can be suppressed.

### Other Modifications

Note that, in addition to the embodiments, various modifications can be made to various technical characteristics disclosed in the present specification without departing from the spirit of the technical creation. That is, it is to be understood that the above embodiments are illustrative in all respects and not restrictive, and the technical scope of the invention is defined by the claims, and includes all modifications falling within the meaning and scope equivalent to the claims.

What is claimed is:

1. A light curtain that includes
a light projector including a plurality of first light projecting elements,
a light receiver arranged to face the light projector, and including a plurality of first light receiving elements configured to receive light beams projected from the plurality of first light projecting elements, and
a synchronization unit configured to synchronize a light projection timing of the light projector and a light reception timing of the light receiver by optical communication,
a safety signal generated based on whether or not each of a plurality of optical axes formed between the light projector and the light receiver is in a light shielding state being output to an outside, the light curtain comprising:
a first operation indicator lamp provided in the light projector and configured to display an operation state of the light curtain;
a second operation indicator lamp provided in the light receiver and configured to display the operation state of the light curtain;
at least one set of optical elements provided in each of the light projector and the light receiver and configured to interlock and display the first operation indicator lamp and the second operation indicator lamp; and
a control circuit configured to interlock and display the first operation indicator lamp and the second operation indicator lamp by using the at least one set of optical elements.

2. The light curtain according to claim 1, wherein the at least one set of optical elements includes a second light projecting element provided in the light receiver and a second light receiving element provided in the light projector.

3. The light curtain according to claim 2, wherein a plurality of sets of the second light projecting element and the second light receiving element are provided.

4. The light curtain according to claim 2, wherein the second light projecting element is a light emitting diode, and the second light receiving element is a photodiode or a phototransistor.

5. The light curtain according to claim 2, wherein, in the second light projecting element, at least one of a light projection spread angle and a lens size is larger than the first light projecting element, and in the second light receiving element, at least one of a light reception viewing angle and a lens size is larger than the first light receiving element.

6. The light curtain according to claim 2, wherein a first optical axis for light incident and light shielding detection or timing synchronization is formed between the first light projecting element and the first light receiving element, and a second optical axis for interlocking and display control different from the first optical axis is formed between the second light projecting element and the second light receiving element.

7. The light curtain according to claim 6,
wherein a first period in which each of the first light projecting element and the first light receiving element is driven and a second period in which each of the second light projecting element and the second light receiving element is driven are repeated in a time division manner, and
the light receiver drives the second optical axis in the second period in accordance with a detection result of the first optical axis obtained in each of a plurality of the first periods.

8. The light curtain according to claim 7, wherein, when optical communication via the second optical axis is not established in the second period, the first operation indicator lamp is maintained in a display state so far.

9. The light curtain according to claim 8, wherein, when optical communication via the second optical axis is not established continuously over a plurality of the second periods, the first operation indicator lamp is switched to a turned-off state or a display state indicating a turned-off state of the safety signal.

10. The light curtain according to claim 6, wherein the light receiver includes a light shielding wall formed to shield light going around the first light receiving element from a light guide path of the second light projecting element.

11. The light curtain according to claim 2, wherein the second light projecting element is arranged between the plurality of first light receiving elements, and the second light receiving element is arranged between the plurality of first light projecting elements.
